(19) United States
(12) Patent Application Publication
(10) Pub. No.: US 2026/0038226 A1
(43) Pub. Date: Feb. 5, 2026

(54) ELECTRONIC DEVICE AND CONTROL METHOD THEREOF

(71) Applicant: SAMSUNG ELECTRONICS CO., LTD., Suwon-si (KR)

(72) Inventors: Dongwon KIM, Suwon-si (KR); Donghoon LEE, Suwon-si (KR); Sangshin PARK, Suwon-si (KR); Eunae CHO, Suwon-si (KR); Yunjoo CHOI, Suwon-si (KR)

(73) Assignee: SAMSUNG ELECTRONICS CO., LTD., Suwon-si (KR)

(21) Appl. No.: 19/353,028

(22) Filed: Oct. 8, 2025

Related U.S. Application Data
(63) Continuation of application No. PCT/KR2024/002021, filed on Feb. 13, 2024.

(30) Foreign Application Priority Data
Apr. 12, 2023 (KR) 10-2023-0048223
Sep. 6, 2023 (KR) 10-2023-0118613

(51) Int. Cl. G06V 10/25; G06T 7/90; G06V 10/60

(52) U.S. Cl. CPC G06V 10/25; G06T 7/90; G06V 10/60; G06T 2207/10024; G06T 2207/30201

(57) ABSTRACT

An electronic device which comprises: a display; a memory which stores a background image; and at least one processor which identifies a first captured image is acquired, identifies a region of interest including a user's face from the first captured image; acquires skin color information corresponding to the user's face on the basis of the region of interest; acquires a brightness range of the display and a color range of a background image on the basis of the skin color information; controls the display to display a background image based on a target brightness value acquired and the brightness range and a target color value acquired based on the color range; and acquires biometric information based on a second captured image which includes the user face of the first captured image, being acquired after the background image is displayed.

### CROSS-REFERENCE TO RELATED APPLICATION

This application is a continuation application is a continuation application, under 35 U.S.C. § 111(a), of international application No. PCT/KR2024/002021, filed Feb. 13, 2024, which claims priority under 35 U. S. C. § 119 to Korean Patent Application No. 10-2023-0048223, filed Apr. 12, 2023, and Korean Patent Application No. 10-2023-0118613, filed Sep. 6, 2023, the disclosures of which are incorporated herein by reference in their entireties.

### TECHNICAL FIELD

The present disclosure relates to an electronic device and a control method thereof, and more particularly to an electronic device for analyzing a user-captured image, and a control method thereof.

### BACKGROUND ART

A user biological signal may be analyzed based on a user-captured image. If a user skin color is identified from the captured image, a user health-related biological signal may be analyzed based on the skin color. A user health state may vary depending on skin color brightness, skin color changes, or the like.

The electronic device may analyze the captured image (or a photographed image) to provide an analysis result for the user health state. However, if the captured image has poor quality, the analysis results may have low accuracy. For example, if a user is captured in a backlit or dark environment, it may be difficult to identify the user skin color from the captured image.

It may be difficult to extract a human landmark if a bright background color of a display illuminates a person having a light skin color.

Information of existing original data may be changed if the captured image itself is converted into a bright image or upscaled, thereby reducing the accuracy or reliability of the image.

### DISCLOSURE OF INVENTION

### Solution to Problem

The present disclosure provides an electronic device for outputting a background image based on a target luminance value and a target color value and acquiring user biological information based on a captured image acquired while the background image is displayed, and a control method thereof.

According to an embodiment of the present disclosure, provided is an electronic device including: a display; a memory to store a background image; and at least one processor configured to identify a region of interest including a user face from a first captured image acquired, acquire skin color information corresponding to the user face based on the region of interest, acquire a luminance range of the display and a color range of the background image based on the skin color information, control the display to display the background image based on a target luminance value acquired from the luminance range and a target color value acquired from the color range, and acquire user biological information based on a second captured image, which includes the user face of the first captured image, being acquired after the background image is displayed.

The at least one processor may be configured to acquire the second captured image while the background image is displayed, identify the region of interest including the user face from the second captured image, and acquire the user biological information based on the region of interest.

The at least one processor may be configured to control the display to display the background image for a predetermined time based on the target luminance value and the target color value, and acquire the user biological information based on a color value of the region of interest included in each of the plurality of captured images acquired for the predetermined time.

The biological information may include at least one of blood flow information or heartbeat information.

The at least one processor may be configured to control the display to display a first background image based on a first luminance value corresponding to a minimum luminance value within the luminance range and a first color value within the color range, and acquire the target luminance value and the target color value from the second captured image if the second captured image is acquired after the first background image is displayed.

The at least one processor may be configured to acquire a first brightness value of the region of interest from the second captured image, control the display to display a second background image based on the first luminance value and a second color value that is different from the first color value, and acquire the target luminance value and the target color value from a third captured image if the third captured image including the user is acquired after the second background image is displayed based on the first luminance value.

The at least one processor may be configured to acquire a second brightness value of the region of interest from the third captured image, acquire a signal-to-noise ratio (SNR) corresponding to a green channel from the region of interest in the third captured image if the second brightness value exceeds the first brightness value, and acquire the target luminance value and the target color value based on the signal-to-noise ratio (SNR).

The at least one processor may be configured to change the first luminance value to a second luminance value if the second brightness value does not exceed the first brightness value, control the display to display the second background image based on the second luminance value and the second color value, acquire a third brightness value of the region of interest from a fourth captured image if the fourth captured image including the user is acquired after the second background image is displayed based on the second luminance value, acquire the signal-to-noise ratio (SNR) corresponding to the green channel from the region of interest in the fourth captured image if the third brightness value exceeds the first brightness value, and acquire the target luminance value and the target color value based on the signal-to-noise ratio (SNR).

The at least one processor may be configured to determine whether the signal-to-noise ratio (SNR) exceeds a pre-stored maximum signal-to-noise ratio (SNR-max) if the signal-to-noise ratio (SNR) exceeds a threshold value, update the pre-stored maximum signal-to-noise ratio (SNR-max) to the signal-to-noise ratio (SNR) if the signal-to-noise ratio (SNR) exceeds the pre-stored maximum signal-to-noise ratio (SNR-max), acquire a luminance value used to acquire the signal-to-noise ratio (SNR) as the target luminance value, and acquire a color value used to acquire the signal-to-noise ratio (SNR) as the target color value.

The at least one processor may be configured to control the display to display a third background image based on the first luminance value and a third color value that is different from the second color value if the signal-to-noise ratio (SNR) does not exceed the threshold value, and acquire the target luminance value and the target color value from a fifth captured image including the user after the third background image is displayed based on the first luminance value.

According to an embodiment of the present disclosure, provided is a control method of an electronic device including a display to display a background image, the method including: identifying a region of interest including a user face from a first captured image acquired; acquiring skin color information corresponding to the user face based on the region of interest; acquiring a luminance range of the display and a color range of the background image based on the skin color information; displaying the background image based on a target luminance value acquired from the luminance range and a target color value acquired from the color range; and acquiring user biological information based on a second captured image, which includes the user face of the first captured image, being acquired after the background image is displayed.

In the acquiring of the user biological information, the second captured image may be acquired while the background image is displayed, the region of interest including the user face may be identified from the second captured image, and the user biological information may be acquired based on the region of interest.

In the acquiring of the user biological information, the background image may be displayed for a predetermined time based on the target luminance value and the target color value, and the user biological information may be acquired based on a color value of the region of interest included in each of the plurality of captured images acquired for the predetermined time.

The biological information may include at least one of blood flow information or heartbeat information.

The method may further include: displaying a first background image based on a first luminance value corresponding to a minimum luminance value within the luminance range and a first color value within the color range; and acquiring the target luminance value and the target color value from the second captured image if the second captured image is acquired after the first background image is displayed.

In the acquiring of the target luminance value and the target color value, a first brightness value of the region of interest may be acquired from the second captured image, a second background image may be displayed based on the first luminance value and a second color value that is different from the first color value, and the target luminance value and the target color value may be acquired from a third captured image if the third captured image including the user is acquired after the second background image is displayed based on the first luminance value.

In the acquiring of the target luminance value and the target color value, a second brightness value of the region of interest may be acquired from the third captured image, a signal-to-noise ratio (SNR) corresponding to a green channel may be acquired from the region of interest in the third captured image if the second brightness value exceeds the first brightness value, and the target luminance value and the target color value may be acquired based on the signal-to-noise ratio (SNR).

In the acquiring of the target luminance value and the target color value, the first luminance value may be changed to a second luminance value if the second brightness value does not exceed the first brightness value, the second background image may be displayed based on the second luminance value and the second color value, a third brightness value of the region of interest may be acquired from a fourth captured image if the fourth captured image including the user is acquired after the second background image is displayed based on the second luminance value, the signal-to-noise ratio (SNR) corresponding to the green channel may be acquired from the region of interest in the fourth captured image if the third brightness value exceeds the first brightness value, and the target luminance value and the target color value may be acquired based on the signal-to-noise ratio (SNR).

In the acquiring of the target luminance value and the target color value, whether the signal-to-noise ratio (SNR) exceeds a pre-stored maximum signal-to-noise ratio (SNR-max) may be determined if the signal-to-noise ratio (SNR) exceeds a threshold value, update the pre-stored maximum signal-to-noise ratio (SNR-max) to the signal-to-noise ratio (SNR) if the signal-to-noise ratio (SNR) exceeds the pre-stored maximum signal-to-noise ratio (SNR-max), a luminance value used to acquire the signal-to-noise ratio (SNR) may be acquired as the target luminance value, and a color value used to acquire the signal-to-noise ratio (SNR) may be acquired as the target color value.

In the acquiring of the target luminance value and the target color value, a third background image may be displayed based on the first luminance value and a third color value that is different from the second color value if the signal-to-noise ratio (SNR) does not exceed the threshold value, and the target luminance value and the target color value may be acquired from a fifth captured image including the user after the third background image is displayed based on the first luminance value.

### BRIEF DESCRIPTION OF DRAWINGS

FIG. 1 is a view for describing an operation for capturing a user according to an embodiment.

FIG. 2 is a block diagram showing an electronic device according to an embodiment.

FIG. 3 is a block diagram for describing a specific configuration of the electronic device shown in FIG. 2 according to an embodiment.

FIG. 4 is a view for describing a module performing an image analysis operation according to an embodiment.

FIG. 5 is a flowchart for describing an operation for analyzing a biological signal by analyzing a captured image according to an embodiment.

FIG. 6 is a flowchart for describing a recapture operation according to an embodiment.

FIG. 7 is a flowchart for describing an operation for increasing display brightness (or display luminance) according to an embodiment.

FIG. 8 is a flowchart for describing an operation for comparing illuminance values according to an embodiment.

FIG. 9 is a flowchart for describing an operation for comparing brightness values according to an embodiment.

FIG. 10 is a flowchart for describing an operation for comparing contrast values according to an embodiment.

FIG. 11 is a flowchart for describing an operation for comparing the brightness values and the contrast values according to an embodiment.

FIG. 12 is a flowchart for describing an operation for comparing green values according to an embodiment.

FIG. 13 is a flowchart for describing an operation for comparing signal-to-noise ratios (SNRs) of the green values according to an embodiment.

FIG. 14 is a flowchart for describing an operation for comparing the brightness values, the contrast values, or signal-to-noise ratios (SNRs) of the green values according to an embodiment.

FIG. 15 is a flowchart for describing an operation for controlling a method for adjusting the display brightness differently depending on an attribute value type according to an embodiment.

FIG. 16 is a view for describing a screen for guiding the recapture according to an embodiment.

FIG. 17 is a view for describing a screen for selecting a brightness adjustment method.

FIG. 18 is a view for describing a brightness adjustment region according to an embodiment.

FIG. 19 is a view for describing a screen on which the brightness is adjusted in a real-time capture stage according to an embodiment.

FIG. 20 is a view for describing an operation for selecting a plurality of brightness adjustment methods according to an embodiment.

FIG. 21 is a view for describing the image analysis operation by using a plurality of devices according to an embodiment.

FIG. 22 is a flowchart for describing the image analysis operation by a server according to an embodiment.

FIG. 23 is a flowchart for describing the image analysis operation by an external device according to an embodiment.

FIG. 24 is a flowchart for describing a control method of an electronic device according to an embodiment according to an embodiment.

FIG. 25 is a flowchart for describing an operation for determining a target color value and a target luminance value according to an embodiment.

FIG. 26 is a flowchart for describing an operation for determining the target color value and the target luminance value according to an embodiment.

FIG. 27 is a flowchart for describing an operation for determining the target color value and the target luminance value according to an embodiment.

FIG. 28 is a flowchart for describing an operation for determining the target color value and the target luminance value according to an embodiment.

FIG. 29 is a view for describing a region of interest according to an embodiment.

FIG. 30 is a flowchart for describing a control method of an electronic device according to an embodiment.

### MODE FOR INVENTION

Hereinafter, the embodiments of the present disclosure are described in detail with reference to the accompanying drawings.

General terms that are currently widely used are selected as terms used in embodiments of the present disclosure in consideration of their functions in the present disclosure, and may be changed based on the intention of those skilled in the art or a judicial precedent, the emergence of a new technique, or the like. In addition, in a specific case, terms arbitrarily chosen by an applicant may exist. In this case, the meanings of such terms are mentioned in detail in corresponding descriptions of the present disclosure. Therefore, the terms used in the present disclosure need to be defined based on the meanings of the terms and the contents throughout the present disclosure rather than simple names of the terms.

In the present disclosure, an expression “have”, “may have”, “include”, “may include” or the like, indicates existence of a corresponding feature (for example, a numerical value, a function, an operation or a component such as a part), and does not exclude existence of an additional feature.

An expression, “at least one of A or/and B” may indicate either “A or B”, or “both of A and B.”

Expressions “first”, “second” and the like, used in the present disclosure may indicate various components regardless of the sequence or importance of the components. The expression is used only to distinguish one component from another component, and does not limit the corresponding component.

If any component (for example, a first component) is mentioned to be “(operatively or communicatively) coupled with/to” or “connected to” another component (for example, a second component), it should be understood that the any component is directly coupled to another component or may be coupled to another component through yet another component (for example, a third component).

A term of a singular number may include its plural number unless explicitly indicated otherwise in the context. It should be understood that a term “include” or “have” used in this application specifies the presence of features, numerals, steps, operations, components, parts, or combinations thereof, which are mentioned in the specification, and does not preclude the presence or addition of one or more other features, numerals, steps, operations, components, parts, or combinations thereof.

In the present disclosure, a “module” or a “˜er/˜or” may perform at least one function or operation, and be implemented by hardware, software, or a combination of hardware and software. In addition, a plurality of “modules” or a plurality of “˜ers/˜ors” may be integrated in at least one module and be implemented by the processor (not shown) except for a “module” or a “˜er/or” that needs to be implemented by a specific hardware.

In the specification, such a term as a “user” may refer to a person who uses the electronic device or an apparatus (for example, an artificial intelligence electronic device) which uses the electronic device.

Hereinafter, an embodiment of the present disclosure is described in detail with reference to the accompanying drawings.

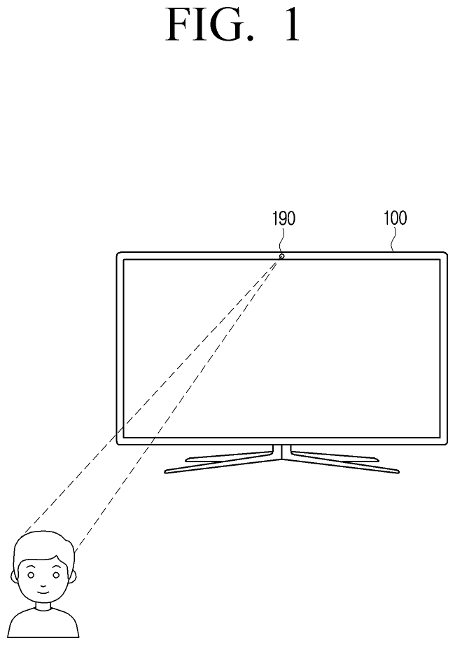

FIG. 1 is a view for describing an operation for capturing a user.

Referring to FIG. 1, an electronic device 100 may capture a user 10 by using a camera 190. The electronic device 100 may acquire a captured image including the user 10. The electronic device 100 may perform a biological analysis operation based on the captured image.

The electronic device 100 may analyze a biological signal of the user 10 included in the captured image. The electronic device 100 may analyze the user biological signal of the user based on a skin color of the user 10. The biological signal may include heart rate, heart rate variability, or the like. The biological signal may include a liver function test result and a jaundice test result.

The operation for analyzing the biological signal may be referred to as remote photoplethysmography (rPPG). The rPPG may be a method for additionally using a red-green-blue (RGB) camera based on a principle of an existing PPG method (a method for estimating a heartbeat signal by sensing a blood flow that changes due to a heartbeat as a time series signal using an optical sensor). The rPPG may calculate a change in a human skin color based on a change in light reflected from a subject by using the RGB camera.

The rPPG method may measure a human heart rate without contact based on the calculated change in the skin color. The rPPG may be a type of computer vision-based technology for estimating heart activity by a change in a facial skin color due to the heartbeat.

The heart rate refers to the number of beats per minute of the heart, which may be matched with a pulse rate. A resting value for adults/an adult may be 60 to 70. The resting value may vary depending on an environmental condition.

The heart rate variability refers to a degree of variation in a heartbeat. The heart rate variability may indicate slight changes from one cardiac cycle to the next. The heart rate variability may be described as HRV. The electronic device 100 may analyze whether a sympathetic/parasympathetic nervous system is normally active based on the heart rate variability (HRV).

The electronic device 100 may extract a face object from an image acquired by using the RGB camera. The electronic device 100 may change display brightness (or a background color) to improve accuracy of the rPPG measurement.

The darker the skin color, the more light skin may absorb. The electronic device 100 may increase an amount of light reaching the skin by adding an amount of light from the display. The electronic device 100 may provide an environment where a lot of light is reflected to the camera. The electronic device 100 may adjust the amount of light based on the human skin color. If the person having a light skin color is identified, the electronic device 100 may increase a probability of extracting the landmark by reducing the amount of light output.

Hemoglobin and oxyhemoglobin in blood may have a high absorption rate for a green channel in a light spectrum. Data from the green channel may be used to calculate the heart rate. The electronic device 100 may increase measurement accuracy by increasing a proportion of a green channel value in the background color of the display.

The electronic device 100 may measure the biological signal stably and with high accuracy even in a low-light or backlit environment in case of performing the rPPG measurement on a display using the RGB camera.

A nit may be used as a unit that indicates an amount of light per unit area. The nit may be used to represent the display brightness. A theater screen may output an image having a brightness of 40 to 60 nits. A liquid crystal display (LCD) monitor may output an image having a brightness of 300 nits. An quantum dot light-emitting diode (QLED) television (TV) may output an image having a brightness of 1000 nits.

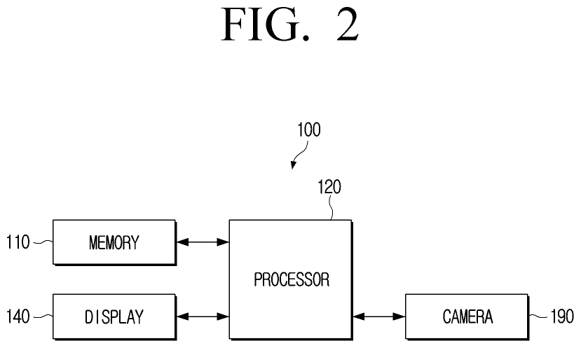

FIG. 2 is a block diagram showing the electronic device 100 according to an embodiment.

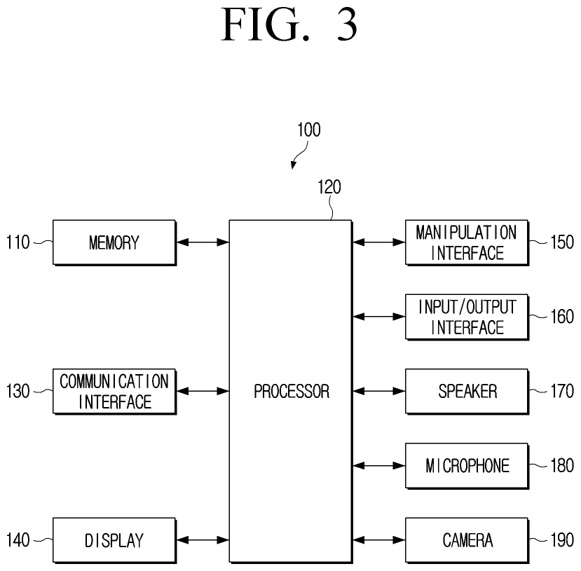

Referring to FIG. 2, the electronic device 100 may include at least one of a memory 110, at least one processor 120, a display 140, or the camera 190. Each component is described with reference to FIG. 3.

The electronic device 100 may include various devices including a display. The electronic device 100 may be an electronic whiteboard, a TV, a desktop personal computer (PC), a laptop, a smartphone, a tablet PC, a server, or the like. The aforementioned examples are only examples for describing the electronic device and are not necessarily limited to the above-described devices.

At least one processor 120 may perform overall control operations of the electronic device 100. At least one processor 120 may function to control overall operations of the electronic device 100.

The memory 110 may store a background image. The background image may be an image output from the electronic device 100. The memory 110 may store at least one predetermined image. The predetermined image may include an image output from the electronic device 100 upon measuring the biological signal. The predetermined image may include the background image.

At least one processor 120 may identify a region of interest including the user face from a first captured image if the first captured image is acquired, acquire skin color information corresponding to the user face based on the region of interest, acquire a luminance range of the display 140 and a color range of the background image based on the skin color information, control the display 140 to display the background image based on a target luminance value acquired from the luminance range and a target color value acquired from the color range, and acquire user biological information based on a second captured image if the second captured image including the user is acquired.

At least one processor 120 may acquire the first captured image based on a user input. The user input may include a command to acquire the biological information. The user input may include a control command to execute a predetermined application to acquire the biological information. The user input may include a command to start the rPPG measurement to analyze the user biological signal.

At least one processor 120 may acquire the first captured image based on the user input.

For example, at least one processor 120 may acquire the captured image by using a sensor part included in the electronic device 100. The sensor part may include the camera 190.

For example, at least one processor 120 may receive the captured image from an external server via a communication interface 130 of the electronic device 100.

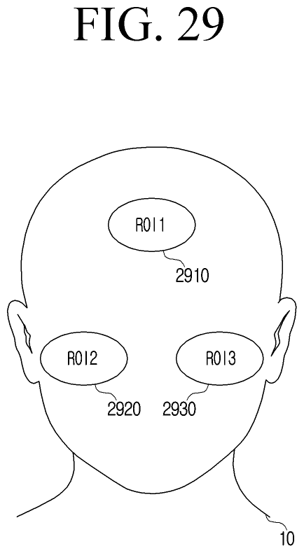

At least one processor 120 may identify a user object by analyzing the first captured image. The first captured image may include the user. At least one processor 120 may identify a user face object from the first captured image. At least one processor 120 may identify (or determine) a region representing the user face object as the region of interest. At least one processor 120 may acquire (or determine) a region in which the user face object is positioned among all regions of the first captured image as the region of interest. A description related to the region of interest is described with reference to FIG. 29.

At least one processor 120 may acquire the user skin color information based on the region of interest. The skin color information may include a color value related to user skin. The skin color is different for each person, and at least one processor 120 may thus determine the skin color based on the first captured image. At least one processor 120 may acquire (or calculate) the color value related to the user skin by using a color value (a RGB value) of the first captured image. The skin color may represent the facial skin color of the user.

At least one processor 120 may determine one of a plurality of skin color types pre-classified based on the first captured image. A skin color range may be pre-classified. At least one processor 120 may determine a type corresponding to the user among the plurality of classified types.

For example, assume that the darkest skin type is determined as a first type and the lightest skin type is classified as a tenth type in relation to the skin color. At least one processor 120 may determine the skin type (or the skin color type) corresponding to the user based on a color value of the region of interest included in the first captured image.

At least one processor 120 may acquire the luminance range of the display 140 and the color range of the background image based on the skin color information including the skin type.

Luminance may be described as the same concept as brightness. For convenience of description, a part related to an output of the display 140 is described as luminance, and a part related to colors of the background image and the captured image is described as brightness.

The display 140 may include a device that outputs a light from a light source. At least one processor 120 may adjust an output intensity of the light source based on hardware characteristics of the display 140. A luminance value may vary depending on the output intensity of the light source. A luminance range may represent a range from a minimum luminance value to a maximum luminance value. A setting value of the display may include the luminance value.

The luminance range of the display 140 may vary depending on the skin color information.

The color range of the background image may vary depending on the skin color information.

At least one processor 120 may pre-store a luminance range corresponding to the skin type and a color range corresponding to the skin type in the memory 110.

At least one processor 120 may store a skin color-luminance range table (or a skin type-luminance range table) including the luminance range corresponding to each of the plurality of skin types. The skin color-luminance range table may be described as a first table. At least one processor 120 may acquire the luminance range corresponding to the skin type based on the first table.

At least one processor 120 may store a skin color-color range table (or a skin type-color range table) including the color range corresponding to each of the plurality of skin types. The skin color-color range table may be described as a second table. At least one processor 120 may acquire the color range corresponding to the skin type based on the second table.

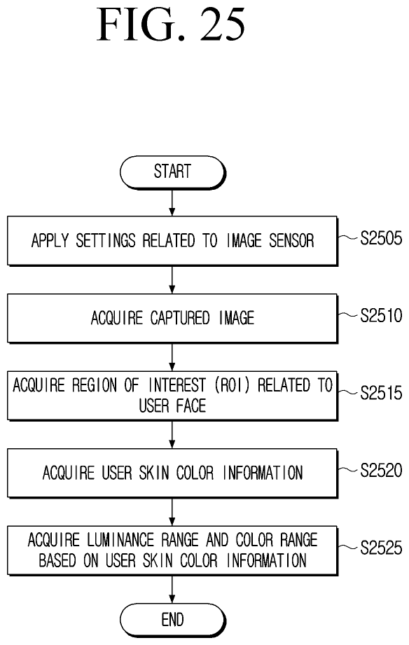

A configuration for acquiring the luminance range and the color range is described with reference to FIG. 25.

At least one processor 120 may determine the target luminance value and the target color value based on the luminance range and the color range.

The target luminance value may include a luminance intensity of the display 140 used to output the background image.

The target color value may include a value representing a color of the background image.

The electronic device 100 may require a clear captured image to acquire highly accurate user biological information. For the clear captured image, the electronic device 100 may output the background image to provide an appropriate illumination effect. If the background image is too bright, the accuracy of the biological information may rather be reduced. The electronic device 100 may need to output the background image based on an appropriate level of the luminance value or the color value. The electronic device 100 may calculate the target luminance value and the target color value to acquire an accurate value used to output the background image.

At least one processor 120 may control the display 140 to display the background image based on the target luminance value and the target color value.

At least one processor 120 may acquire the second captured image while the background image is displayed, identify the region of interest including the user face from the second captured image, and acquire the user biological information based on the region of interest.

At least one processor 120 may acquire a new captured image (i.e., the second captured image) after the background image is displayed. At least one processor 120 may acquire the biological information based on the second captured image. The second captured image may include the user face object having a color value enhanced by the background image output based on the target luminance value and the target color value. At least one processor 120 may perform a measurement function for acquiring the user biological information based on the second captured image. The measurement function may include a remote photoplethysmography (rPPG) function.

At least one processor 120 may control the display 140 to display the background image for a predetermined time based on the target luminance value and the target color value, acquire the plurality of captured images for the predetermined time, and acquire the user biological information based on the color value of the region of interest included in each of the plurality of captured images.

At least one processor 120 may acquire the user biological information based on the plurality of captured images captured for the predetermined time. Analyzing the user face based on only one captured image may have relatively low accuracy. At least one processor 120 may acquire the user biological information by analyzing the plurality of captured images. The predetermined time may be changed.

The biological information may include at least one of blood flow information or heartbeat information.

At least one processor 120 may control the display 140 to display a first background image based on a first luminance value corresponding to a minimum luminance value within the luminance range and a first color value within the color range, and acquire the target luminance value and the target color value from the second captured image if the second captured image is acquired after the first background image is displayed.

At least one processor 120 may control the display 140 to have the minimum luminance value (or the first luminance value) within the luminance range corresponding to the skin type. At least one processor 120 may display the first background image based on the first color value included in the color range. For example, the first color value may be a minimum color value within the color range.

The background image itself may include the color value, and the background image having a different color value may therefore be described as the first background image, a second background image, or the like.

However, in some implementation examples, it may be described that the background image is the same and that the color value is controlled differently to output the image.

At least one processor 120 may acquire the second captured image including the user while the first background image is displayed. At least one processor 120 may determine the target luminance value and the target color value from the second captured image. At least one processor 120 may determine the target luminance value and the target color value by comparing the first captured image with the second captured image.

At least one processor 120 may acquire a first brightness value of the region of interest from the second captured image, control the display 140 to display the second background image based on the first luminance value and a second color value that is different from the first color value, and acquire the target luminance value and the target color value from a third captured image if the third captured image including the user is acquired after the second background image is displayed based on the first luminance value.

At least one processor 120 may change a color value of the background image. This configuration is provided to search for a background color suitable for the biological signal analysis by outputting various background colors (or the color value of the background image).

At least one processor 120 may acquire the second captured image while the first background image is output based on the first color value. At least one processor 120 may acquire the third captured image while the second background image is output based on the second color value.

At least one processor 120 may determine the target luminance value and the target color value from the third captured image. At least one processor 120 may determine the target luminance value and the target color value by comparing the second captured image with the third captured image.

At least one processor 120 may acquire the first brightness value of the region of interest from the second captured image. At least one processor 120 may acquire a second brightness value of the region of interest from the third captured image.

At least one processor 120 may compare the first brightness value with the second brightness value. At least one processor 120 may determine the target luminance value and the target color value based on a comparison result.

At least one processor 120 may acquire a signal-to-noise ratio (SNR) corresponding to the green channel from the region of interest in the third captured image if the second brightness value exceeds the first brightness value, and acquire the target luminance value and the target color value based on the signal-to-noise ratio (SNR).

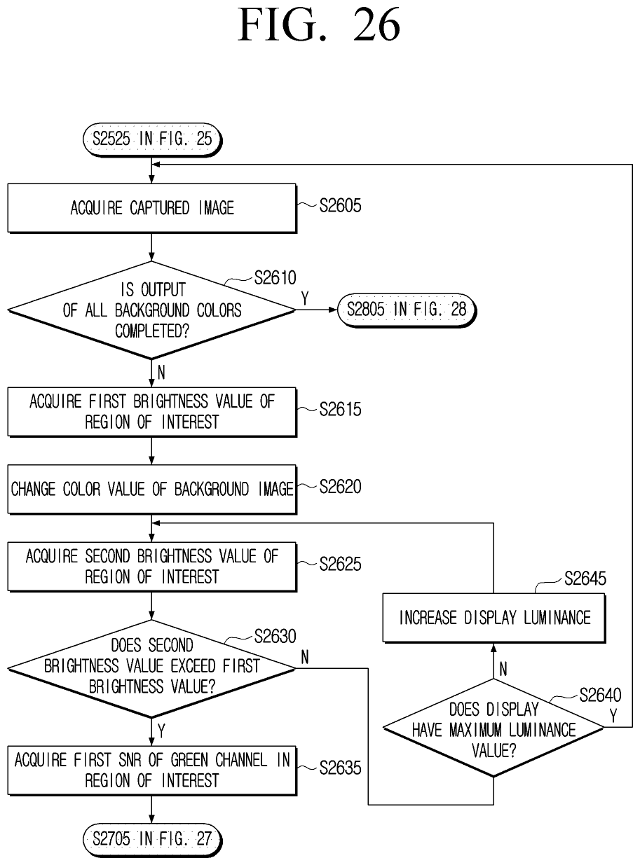

An operation for comparing the first brightness value with the second brightness value by changing the color value of the background image is described with reference to FIG. 26.

At least one processor 120 may change the first luminance value to a second luminance value if the second brightness value does not exceed the first brightness value. At least one processor 120 may control the display 140 to display the second background image based on the second luminance value and the second color value. An operation related to this configuration may correspond to step S2645 in FIG. 26.

At least one processor 120 may acquire a third brightness value of the region of interest from a fourth captured image if the fourth captured image including the user is acquired after the second background image is displayed based on the second luminance value.

At least one processor 120 may acquire the signal-to-noise ratio (SNR) corresponding to the green channel from the region of interest in the fourth captured image if the third brightness value exceeds the first brightness value, and acquire the target luminance value and the target color value based on the signal-to-noise ratio (SNR).

At least one processor 120 may change the color value of the background image from the first color value to the second color value. At least one processor 120 may increase the luminance value of the display by a predetermined unit until a brightness value of the region of interest acquired in a situation where the second background image is output is greater than a brightness value acquired in a situation where the first background image is output. At least one processor 120 may output the second background image by increasing the luminance value by the predetermined unit.

At least one processor 120 may determine whether the signal-to-noise ratio (SNR) exceeds a pre-stored maximum signal-to-noise ratio (SNR-max) if the signal-to-noise ratio (SNR) exceeds a threshold value.

At least one processor 120 may update the pre-stored maximum signal-to-noise ratio (SNR-max) to the signal-to-noise ratio (SNR) if the signal-to-noise ratio (SNR) exceeds the pre-stored maximum signal-to-noise ratio (SNR-max).

At least one processor 120 may acquire a luminance value used to acquire the signal-to-noise ratio (SNR) as the target luminance value, and acquire a color value used to acquire the signal-to-noise ratio (SNR) as the target color value.

At least one processor 120 may control the display 140 to display a third background image based on the first luminance value and a third color value that is different from the second color value if the signal-to-noise ratio (SNR) does not exceed the threshold value.

At least one processor 120 may acquire a fifth captured image including the user while the third background image is displayed. At least one processor 120 may acquire the target luminance value and the target color value from the fifth captured image.

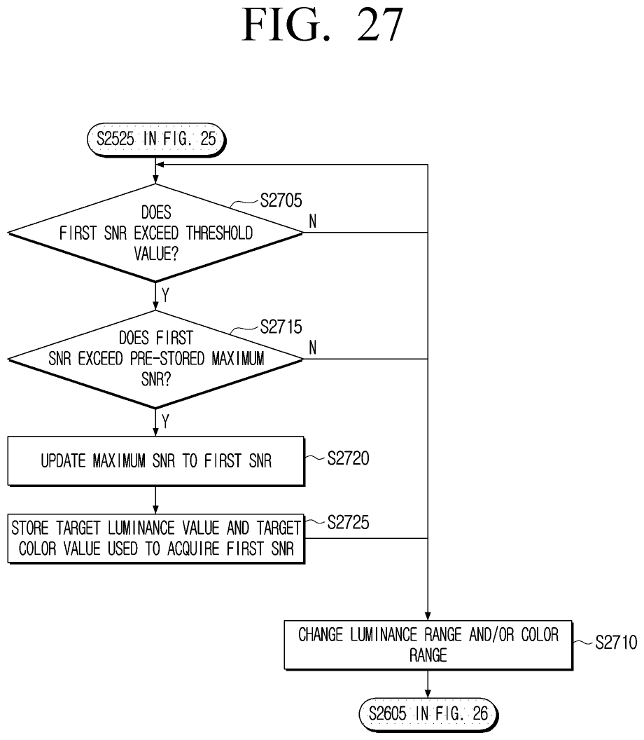

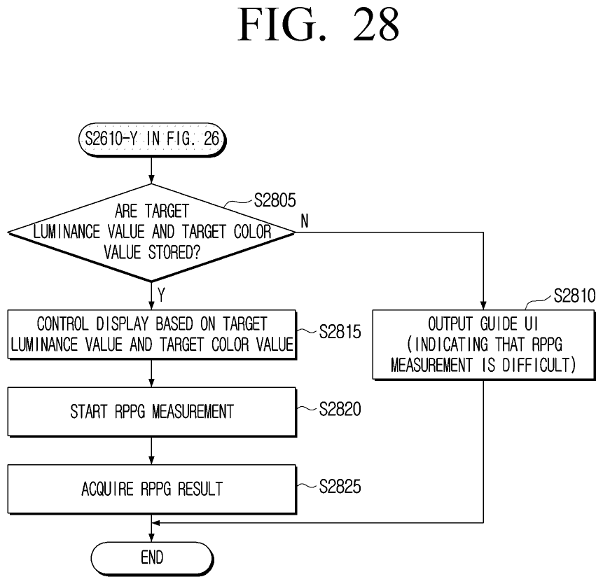

An operation utilizing the signal-to-noise ratio (SNR) is described with reference to FIGS. 27 and 28.

According to various embodiments, at least one processor 120 may provide a user interface (UI) guiding recapture.

At least one processor 120 may identify the region of interest including the user face from the captured image if the captured image is acquired, analyze the user biological signal based on the region of interest if a predetermined attribute value of the region of interest is included in a reference range, and change the setting value of the display 140 and provide the UI guiding the recapture if the predetermined attribute value of the region of interest is not included in the reference range.

The electronic device 100 may include the camera 190. At least one processor 120 may acquire the captured image by using the camera 190. The camera 190 may be the RGB camera. The RGB camera may be a device that senses wavelengths such as red, green, and blue.

The electronic device 100 may identify a human object from the captured image. The electronic device 100 may identify the face object from the human object if the human object is identified. The electronic device 100 may identify (or determine or set) a position corresponding to the face object as the region of interest.

The region of interest may be described as an object region of interest, an object region, a target region, a target object region, or the like.

The region of interest may be a region related to the user face. The region of interest may be described as a face region, a face object region, or the like.

According to the various embodiments, the region of interest may be a region representing a body part of the user other than the user face.

At least one processor 120 may acquire image data (or image information) corresponding to the region of interest if the region of interest is identified. At least one processor 120 may acquire the predetermined attribute value from the image data in the region of interest.

The captured image may include at least one image. The captured image may include a video.

The predetermined attribute value may include at least one of the brightness value, the contrast value, the green value, or a signal-to-noise ratio (SNR) of the green value.

At least one processor 120 may determine whether the captured image is appropriate for analyzing the biological signal by determining whether the predetermined attribute value is included in the reference range.

At least one processor 120 may perform the recapture for analysis reliability if the captured image is not appropriate for the analysis. The predetermined attribute value may not be included in the reference range if the captured image is the same even after the recapture. Therefore, at least one processor 120 may change the setting value of the display.

At least one processor 120 may control the display 140 to increase the brightness of the display 140 by changing the setting value of the display 140.

The electronic device 100 may change the brightness of the display 140 based on the predetermined unit. If the brightness is changed too much at once, the user may feel uncomfortable. The electronic device 100 may gradually change the brightness of the display 140 based on the predetermined unit.

According to the various embodiments, the setting value of the display included in an external device may be changed instead of the display 140 of the electronic device 100.

At least one processor 120 may control the display 140 to increase brightness of a background region included in the UI guiding the recapture.

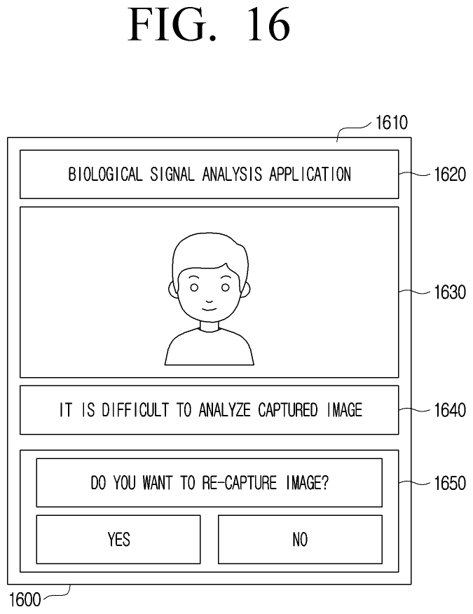

Detailed descriptions related to the guide UI are provided with reference to FIGS. 16 to 20.

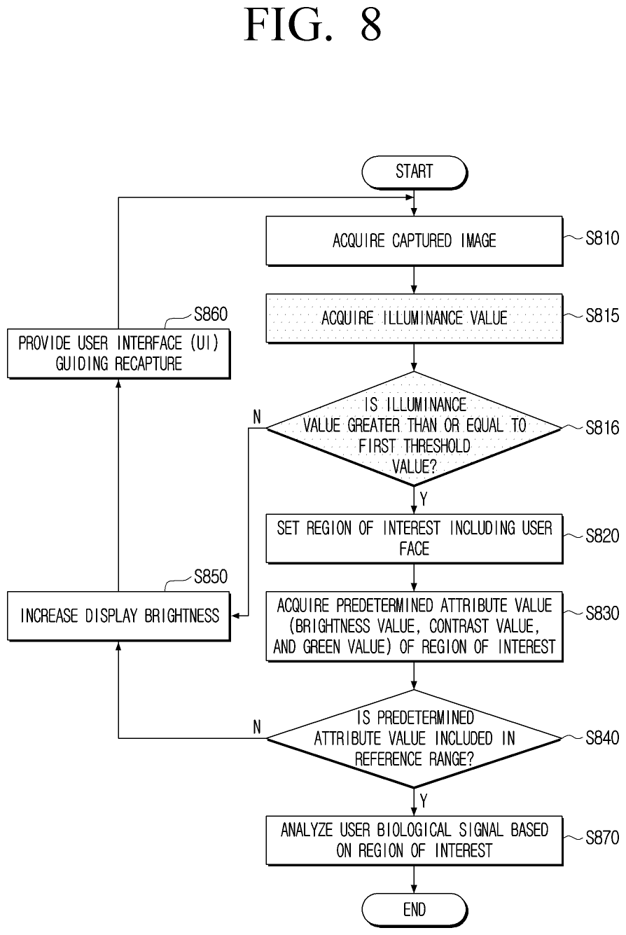

The electronic device 100 may further include an illuminance sensor. At least one processor 120 may acquire an illuminance value from sensing data acquired using the illuminance sensor, and change the setting value of the display 140 if the illuminance value is less than a first threshold value. A detailed description related to this configuration is provided with reference to FIG. 8.

At least one processor 120 may acquire the predetermined attribute value from the image data corresponding to the region of interest, and the predetermined attribute value may include at least one of the brightness value, the contrast value, the green value, or the signal-to-noise ratio (SNR) of the green value.

The brightness value may include a representative brightness value of the region of interest. The representative brightness value may indicate an average brightness value. At least one processor 120 may acquire (or extract) the brightness value of the region of interest from the image data in the region of interest.

The contrast value may include a representative contrast value of the region of interest. The representative contrast value may indicate an average contrast value. At least one processor 120 may acquire (or extract) the contrast value of the region of interest from the image data in the region of interest.

The green value may include a representative green value of the region of interest. The representative green value may indicate an average green value. The green value may be described as a G channel value, a G value, or the like. At least one processor 120 may acquire (or extract) the green value of the region of interest from the image data in the region of interest.

The signal-to-noise ratio (SNR) of the green value may include ratio information representing a relationship between the green value and noise in the region of interest. At least one processor 120 may acquire (or extract) the signal-to-noise ratio (SNR) of the green value (of the region of interest) from the image data in the region of interest.

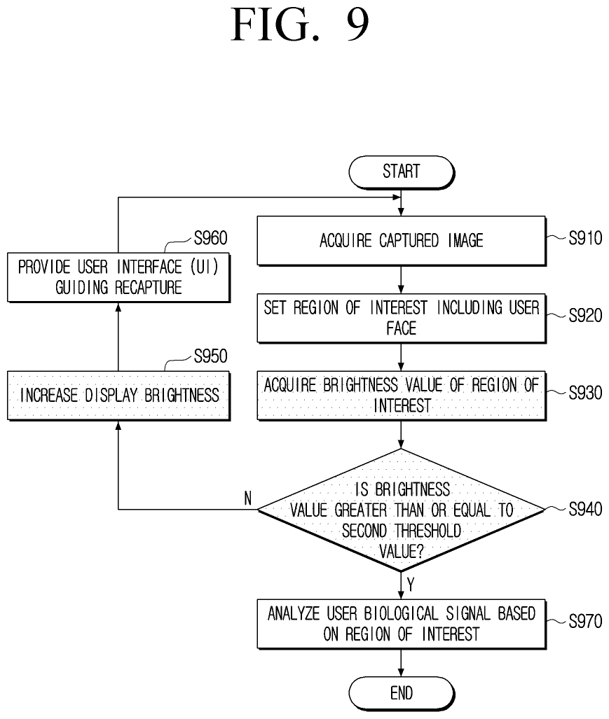

At least one processor 120 may acquire the brightness value corresponding to the region of interest, and change the setting value of the display 140 based on a first control operation if the brightness value is less than a second threshold value. A detailed description related to this configuration is provided with reference to FIG. 9.

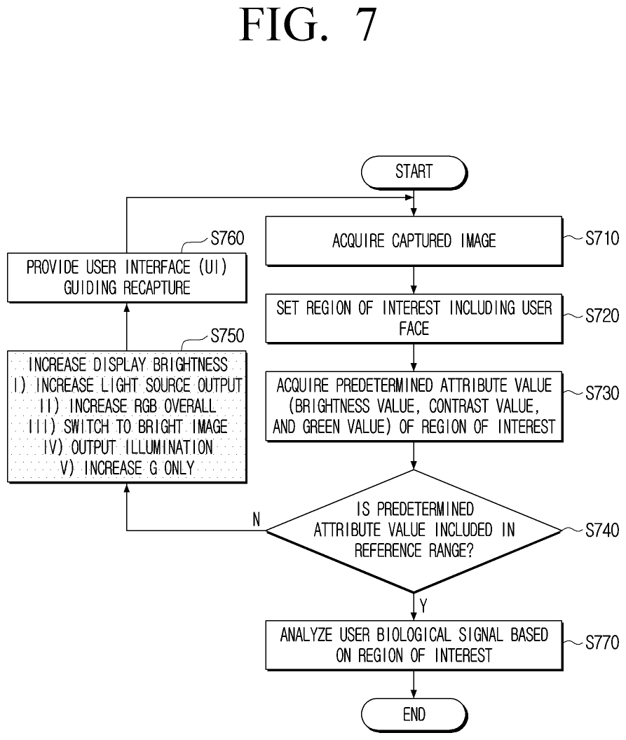

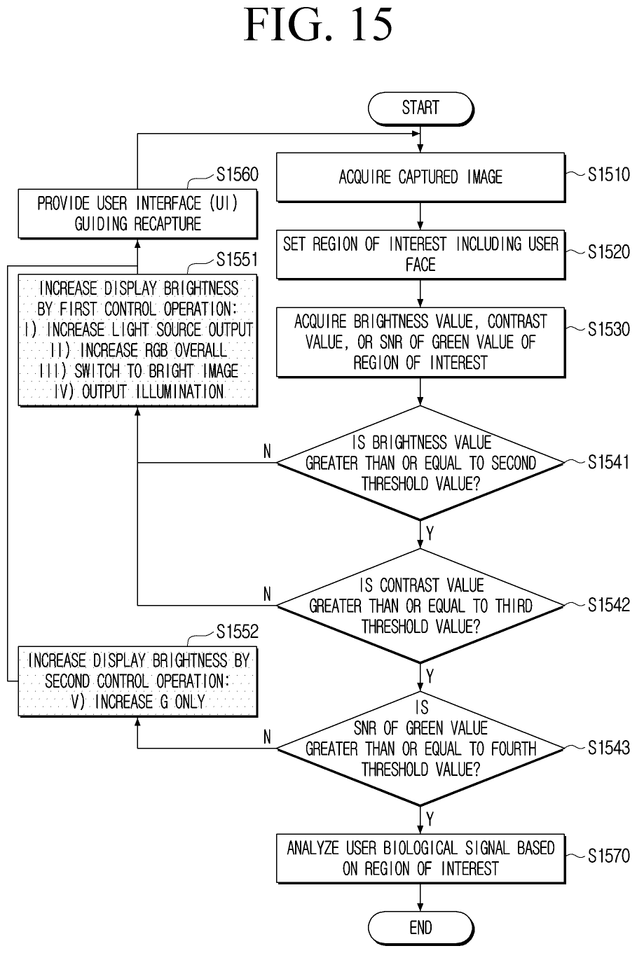

The first control operation may include at least one of an operation for increasing a light source output value of the display 140 (i.e., a first operation), an operation for increasing an RGB value output from the display 140 (i.e., a second operation), an operation for switching an output image (i.e., a third operation), or an operation for outputting illumination (i.e., a fourth operation). A detailed description of the display control operation is provided with reference to FIGS. 7 and 15.

The operation for increasing the light source output value (i.e., the first operation) may include an operation for increasing the luminance value of the display 140.

The operation for increasing the RGB value output from the display 140 (i.e., the second operation) may include an operation for changing (or increasing) the color value of the background image.

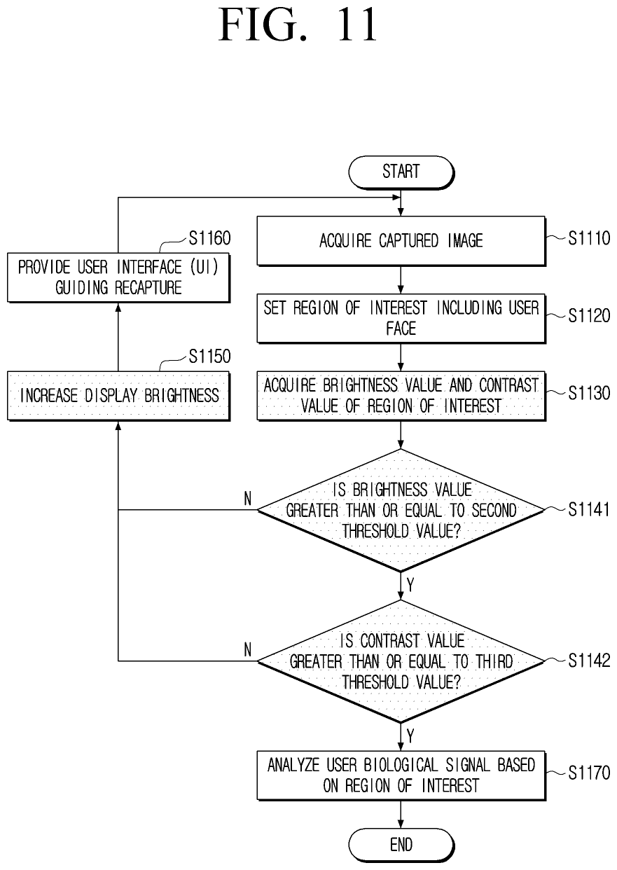

At least one processor 120 may acquire the contrast value corresponding to the region of interest, determine whether the contrast value is greater than or equal to a third threshold value if the brightness value is greater than or equal to the second threshold value, and change the setting value of the display 140 based on the first control operation if the contrast value is less than the third threshold value. A detailed description related to this configuration is provided with reference to FIG. 11.

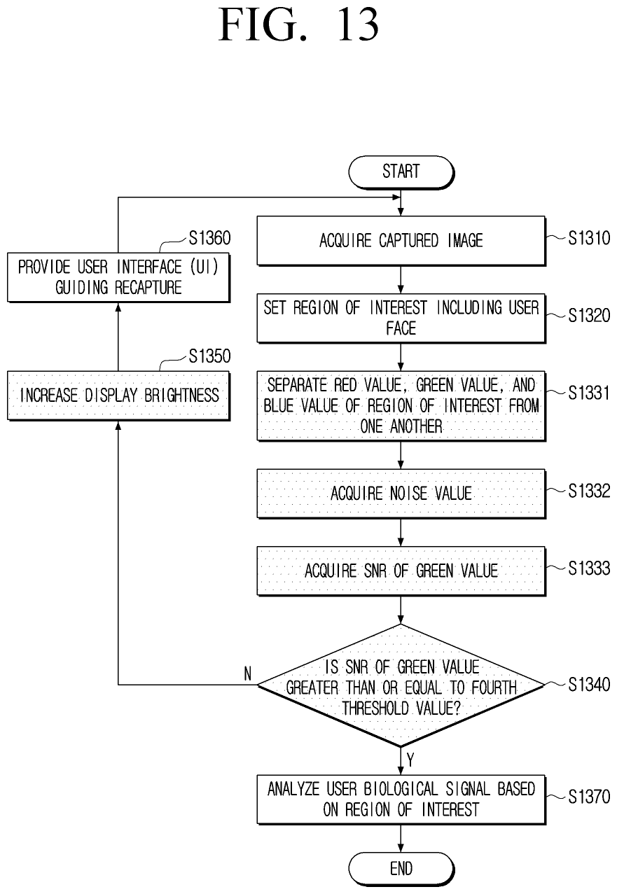

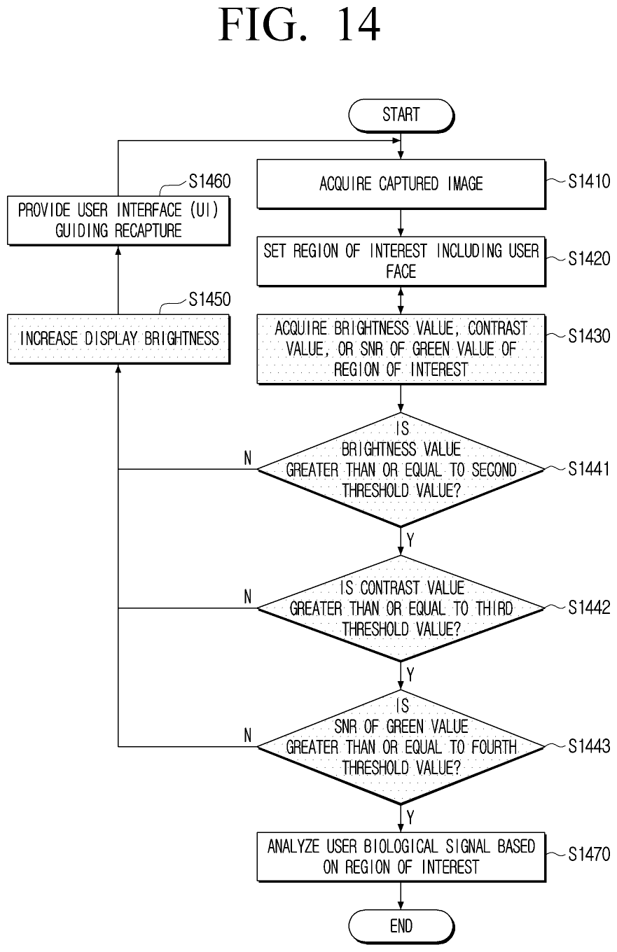

At least one processor 120 may acquire the signal-to-noise ratio (SNR) of the green value corresponding to the region of interest, and change the setting value of the display 140 based on the second control operation if the signal-to-noise ratio (SNR) of the green value is less than the fourth threshold value. A detailed description related to this configuration is provided with reference to FIGS. 13 and 14.

A second control operation may include an operation (i.e., a fifth operation) for increasing the green value output from the display 140. A detailed description of the display control operation is provided with reference to FIGS. 7 and 15.

The first operation, the second operation, the third operation, the fourth operation, and the fifth operation may all be operations for increasing the brightness output from the display. As the display brightness increases, a brighter captured image may be acquired. The brighter the captured image, the more accurately the user skin may be identified, thereby improving accuracy of the biological signal analysis.

FIG. 3 is a block diagram for describing a specific configuration of the electronic device 100 shown in FIG. 2.

Referring to FIG. 3, the electronic device 100 may include at least one of the memory 110, at least one processor 120, the communication interface 130, the display 140, a manipulation interface 150, an input/output interface 160, a speaker 170, a microphone 180, and the camera 190.

The memory 110 may be implemented as an internal memory, such as a read only memory (ROM) (for example, an electrically erasable programmable read-only memory (EEPROM)), a random access memory (RAM), or the like, included in at least one processor 120, or may be implemented as a memory separate from at least one processor 120. In this case, the memory 110 may be implemented as a memory embedded in the electronic device 100 or as a memory detachable from the electronic device 100, depending on a purpose of data storage. For example, data for operating the electronic device 100 may be stored in the memory embedded in the electronic device 100, and data for an expanded function of the electronic device 100 may be stored in the memory detachable from the electronic device 100.

The memory embedded in the electronic device 100 may be implemented as at least one of a volatile memory (e.g., a dynamic RAM (DRAM), a static RAM (SRAM), or a synchronous dynamic RAM (SDRAM)) or a non-volatile memory (e.g., a one time programmable ROM (OTPROM), a programmable ROM (PROM), an erasable and programmable ROM (EPROM), an electrically erasable and programmable ROM (EEPROM), a mask ROM, a flash ROM, a flash memory (e.g., a NAND flash or a NOR flash), a hard drive, or a solid state drive (SSD)), and the memory detachable from the electronic device 100 may be implemented as a memory card (e.g., a compact flash (CF), a secure digital (SD), a micro secure digital (Micro-SD), a mini secure digital (Mini-SD), an extreme digital (xD), or a multimedia card (MMC)) or an external memory that may be connected to a universal serial bus (USB) port (e.g., a USB memory).

The memory 110 may store at least one instruction. At least one processor 120 may perform various operations based on the instructions stored in the memory 110.

At least one processor 120 may be implemented as a digital signal processor (DSP), a microprocessor, a time controller (TCON), each of which processes a digital signal. However, the processor 120 is not limited thereto, and may include at least one of a central processing unit (CPU), a micro controller unit (MCU), a micro processing unit (MPU), a controller, an application processor (AP), a graphics-processing unit (GPU), or a communication processor (CP), or an advanced RISC (Reduced Instruction Set Computer) machine (ARM), or may be defined by a relevant term. At least one processor 120 may be implemented as a system-on-chip (SoC), a large scale integration (LSI) that has a processing algorithm embedded therein, or may be implemented as a field programmable gate array (FPGA). At least one processor 120 may perform various functions by executing computer executable instructions stored in the memory.

The communication interface 130 is a component for performing communication with various types of external devices by using various types of communication methods. The communication interface 130 may include a wireless communication module or a wired communication module. Each communication module may be implemented as at least one hardware chip.

The wireless communication module may be a module that communicates with the external device in a wireless manner. For example, the wireless communication module may include at least one of a wireless fidelity (Wi-Fi) module, a Bluetooth module, an infrared communication module, or another communication module.

The Wi-Fi module and Bluetooth module may perform the communication in a Wi-Fi manner and a Bluetooth manner, respectively. In case of using the Wi-Fi module or the Bluetooth module, the communication interface 160 may first transmit and receive various connection information such as a service set identifier (SSID) or a session key, and connect the communication based on this connection information, and then transmit and receive various information.

The infrared communication module may perform the communication based on infrared data association (IrDA) technology that wirelessly transmits data in a short distance using an infrared ray between visible light (visible spectrum) and millimeter waves.

In addition to the above-described communication methods, another communication module may include at least one communication chip performing the communication based on various wireless communication standards such as Zigbee, third generation (3G), third generation partnership project (3GPP), long term evolution (LTE), LTE advanced (LTE-A), fourth generation (4G), and fifth generation (5G).

The wired communication module may be a module for performing the communication with the external device in a wired manner. For example, the wired communication module may include at least one of a local area network (LAN) module, an Ethernet module, a pair cable, a coaxial cable, an optical fiber cable, or an ultra wide-band (UWB) module.

According to the various embodiments, the communication interface 130 may use the same communication module (for example, the Wi-Fi module) to communicate with the external device, such as a remote control device, and the external server.

According to the various embodiments, the communication interface 130 may use a different communication module to communicate with the external device such as the remote control device or the external server. For example, the communication interface 130 may use at least one of the Ethernet module or the Wi-Fi module to communicate with the external server, and may use the Bluetooth module to communicate with the external device such as the remote control device. However, this case is only an embodiment, and the communication interface 130 may use at least one communication module among various communication modules in case of communicating with the plurality of external devices or external servers.

The display 140 may be implemented as various types of displays such as a liquid crystal display (LCD), an organic light emitting diode (OLED) display, a plasma display panel (PDP). The display 140 may include a driving circuit, a backlight unit, and the like, which may be implemented in a form such as an amorphous silicon thin film transistor (a-si TFT), a low temperature poly silicon (LTPS) TFT, or an organic TFT (OTFT). The display 140 may be implemented in a touch screen combined with a touch sensor, a flexible display, a three-dimensional (3D) display, or the like. According to an embodiment, the display 140 may include a bezel housing a display panel as well as the display panel outputting the image. In particular, the bezel may include the touch sensor (not shown) detecting user interaction according to an embodiment.

The manipulation interface 150 may be implemented as a device such as a button, a touch pad, a mouse or a keyboard, or may be implemented in a touchscreen capable of also performing an operation input function in addition to the above-described display function. The button may be any of various types of buttons such as a mechanical button, a touch pad, a wheel or the like, which is positioned in any region, such as a front surface portion, a side surface portion or a rear surface portion, of a body appearance of the electronic device 100.

The input/output interface 160 may be any of a high-definition multimedia interface (HDMI), a mobile high-definition link (MHL), a universal serial bus (USB), a DisplayPort (DP), Thunderbolt, a video graphics array (VGA) port, a red-green-blue (RGB) port, a D-subminiature (D-SUB) or a digital visual interface (DVI). The input/output interface 160 may input/output at least one of audio or video signals. According to an implementation example, the input/output interface 160 may include a port for inputting and outputting only the audio signal and a port for inputting and outputting only the video signal as its separate ports, or may be implemented as a single port for inputting and outputting both the audio signal and the video signal. The electronic device 100 may transmit at least one of the audio signal or the video signal to the external device (for example, an external display device or an external speaker) through the input/output interface 160. An output port included in the input/output interface 160 may be connected to the external device, and the electronic device 100 may transmit at least one of the audio signal or the video signal to the external device through the output port.

The input/output interface 160 may be connected to the communication interface. The input/output interface 160 may transmit information received from the external device to the communication interface, or transmit information received through the communication interface to the external device.

The speaker 170 may be a component outputting various audio data as well as various notification sounds or voice messages.

The microphone 180 may be a component receiving a user voice or another sound, and converting the same into the audio data. The microphone 180 may receive the user voice while activated. For example, the microphone 180 may be integrated with the upper, front, side, or the like of the electronic device 100. The microphone 180 may include various components such as a microphone collecting the user voice in an analog form, an amplifier circuit amplifying the collected user voice, an analog to digital (A/D) conversion circuit sampling the amplified user voice and converting the same into the digital signal, a filter circuit removing a noise component from the converted digital signal, and the like.

The camera 190 may be a component capturing the subject and generating the captured image, and the captured image is a concept that includes both video and still images. The camera 190 may acquire the image of at least one external device, and may be implemented as the camera, a lens, an infrared sensor, or the like.

The camera 190 may include the lens and an image sensor. A type of lens may include a general-purpose lens, the wide-angle lens, a zoom lens, or the like, and may be determined based on the type, feature, and usage environment of the electronic device 100. The image sensor may use a complementary metal oxide semiconductor (CMOS), a charge coupled device (CCD), or the like.

According to the various embodiments, the electronic device 100 may include the display 140. The electronic device 100 may directly display the acquired image or content on the display 140.

According to the various embodiments, the electronic device 100 may not include the display 140. The electronic device 100 may be connected to the external display device and may transmit an image or content stored in the electronic device 100 to the external display device.

The electronic device 100 may transmit the image or content to the external display device along with a control signal for controlling the image or content to be displayed on the external display device. The external display device may be connected to the electronic device 100 via the communication interface 130 or the input/output interface 160. For example, the electronic device 100 may not include the display, such as a set-top box (STB).

The electronic device 100 may include only a small display capable of displaying only simple information such as text information. The electronic device 100 may transmit the image or content to the external display device via the communication interface 130, either in the wired or wireless manner, or transmit the image or content to the external display device via the input/output interface 160.

Various embodiments may be provided in which the electronic device 100 performs an operation corresponding to a user voice signal received through the microphone 180.

According to the various embodiments, the electronic device 100 may control the display 140 based on the user voice signal received through the microphone 180. For example, the electronic device 100 may control the display 140 to display content A if the user voice signal for displaying content A is received.

According to the various embodiments, the electronic device 100 may control the external display device connected to the electronic device 100 based on the user voice signal received through the microphone 180. The electronic device 100 may generate a control signal for controlling the external display device to perform an operation corresponding to the user voice signal on the external display device, and transmit the generated control signal to the external display device. The electronic device 100 may store a remote control application for controlling the external display device. In addition, the electronic device 100 may transmit the generated control signal to the external display device by using at least one communication method among the Bluetooth, Wi-Fi, and infrared methods. For example, the electronic device 100 may transmit a control signal for controlling content A to be displayed on the external display device to the external display device if the user voice signal for displaying content A is received. The electronic device 100 may indicate various terminal devices on which the remote control application may be installed, such as a smartphone, an artificial intelligence speaker.

According to the various embodiments, the electronic device 100 may use the remote control device to control the external display device connected to the electronic device 100 based on the user voice signal received through the microphone 180. The electronic device 100 may transmit, to the remote control device, a control signal for controlling the external display device to perform the operation corresponding to the user voice signal on the external display device. In addition, the remote control device may transmit, to the external display device, a control signal received from the electronic device 100. For example, if the user voice signal for displaying content A is received, the electronic device 100 may transmit, to the remote control device, the control signal for controlling content A to be displayed on the external display device, and the remote control device may transmit the received control signal to the external display device.

The electronic device 100 may receive the user voice signal in various ways.

According to the various embodiments, the electronic device 100 may receive the user voice signal through the microphone 180 included in the electronic device 100.

According to the various embodiments, the electronic device 100 may receive the user voice signal from the external device including the microphone. The external device may indicate the remote control device, the smartphone, or the like. The received user voice signal may be a digital voice signal, or may be an analog voice signal in some implementation examples. The electronic device 100 may receive the user voice signal by using the wireless communication method such as the Bluetooth or the Wi-Fi.

The electronic device 100 may convert the user voice signal in various ways.

According to the various embodiments, the electronic device 100 may acquire the text information corresponding to the user voice signal from the external server. The electronic device 100 may transmit the user voice signal (the audio signal or the digital signal) to the external server. The external server may indicate a voice recognition server. The voice recognition server may convert the user voice signal into the text information by using speech-to-text (STT) function. In addition, the external server may transmit the text information corresponding to the converted user voice signal to the electronic device 100.

According to the various embodiments, the electronic device 100 may acquire the text information corresponding to the user voice signal on its own. The electronic device 100 may directly apply the speech-to-text (STT) function to the digital voice signal to convert the same into the text information and transmit the converted text information to the external server.

The external server may transmit the information to the electronic device 100 in various ways.

According to the various embodiments, the external server may transmit the text information corresponding to the user voice signal to the electronic device 100. The external server may be a server that performs a voice recognition function for converting the user voice signal into the text information.

According to the various embodiments, the external server may transmit, to the electronic device 100, at least one of the text information corresponding to the user voice signal or search result information corresponding to the text information. The external server may be a server that performs a search result providing function for providing the search result information corresponding to the text information in addition to the voice recognition function for converting the user voice signal into the text information. For example, the external server may be a server that performs both the voice recognition function and the search result providing function. As another example, the external server may perform only the voice recognition function and a separate server may perform the search result providing function. The external server may transmit the text information to the separate server to acquire the search result and acquire the search result corresponding to the text information from the separate server.

The electronic device 100 may communicate with the external device and the external server in various ways.

According to the various embodiments, the same communication module may be implemented to perform the communication with the external device and the external server. For example, the electronic device 100 may communicate with the external device by using the Bluetooth module, and the external server may also communicate by using the Bluetooth module.

According to the various embodiments, separate communication modules may be implemented to perform the communication with the external device and the external server. For example, the electronic device 100 may communicate with the external device by using the Bluetooth module, and communicate with the external server by using an Ethernet modem or the Wi-Fi module.

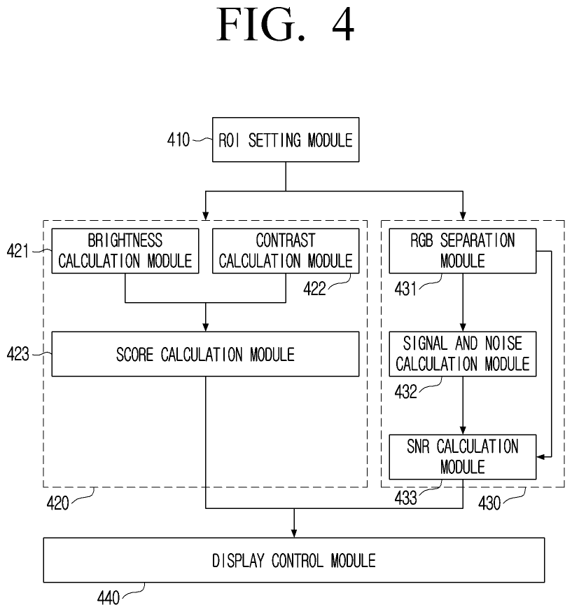

FIG. 4 is a view for describing a module performing an image analysis operation.

Referring to FIG. 4, the electronic device 100 may include at least one of a region of interest (ROI) setting module 410, a first calculation module 420, a second calculation module 430, or a display control module 440.

The region of interest (ROI) setting module 410 may be a module that automatically identifies (or searches for) the region of interest from the captured image. The ROI setting module 410 may acquire the captured image as input data. The ROI setting module 410 may identify the human object from the captured image. If the human object is identified, the ROI setting module 410 may identify the face object from the human object. The ROI setting module 410 may set the position corresponding to the face object as the region of interest.

The ROI setting module 410 may transmit the image data corresponding to the region of interest to at least one of the first calculation module 420 or the second calculation module 430.

The first calculation module 420 may include at least one of a brightness calculation module 421, a contrast calculation module 422, and a score calculation module 423.

The first calculation module 420 may acquire the predetermined attribute value from the image data (or the image information) corresponding to the region of interest acquired by the ROI setting module 410.

The brightness calculation module 421 may be a module that acquires the brightness value of the region of interest. The brightness calculation module 421 may calculate the brightness value acquired from the region of interest and store the calculated value in the memory.

The contrast calculation module 422 may be a module that acquires the contrast value of the region of interest. The contrast calculation module 422 may calculate the contrast value acquired from the region of interest and store the calculated value in the memory.

The score calculation module 423 may be a module that acquires a composite score based on at least one of the brightness value or the contrast value. The score calculation module 423 may transmit the acquired composite score to the display control module.

For example, the composite score may be information including a representative value in which the brightness value and the contrast value are coupled with each other.

For example, the composite score may be information that includes the brightness value and the contrast value separately.

The second calculation module 430 may include at least one of an RGB separation module 431, a signal and noise calculation module 432, and a SNR calculation module 433.

The RGB separation module 431 may separate a red value R, a green value G, and a blue value B from the image data corresponding to the region of interest acquired by the ROI setting module 410. The RGB separation module 431 may extract the red value R, the green value G, and the blue value B based on the region of interest in the captured image.

The noise calculation module 432 may be a module that identifies a noise value from the acquired region of interest. The noise calculation module 432 may transmit the noise value to the SNR calculation module 433.

The SNR calculation module 433 may acquire at least one of the red value R, the green value G, or the blue value B from the RGB separation module 431.

The SNR calculation module 433 may acquire the noise value from the noise calculation module 432.

The SNR calculation module 433 may acquire the signal-to-noise ratio (SNR) based on a target color and the noise value. The target color may be green. The SNR calculation module 433 may acquire the SNR of the green value. The green value may be described as a green channel value, a G channel value, or the like.

The display control module 440 may acquire a calculated value from at least one of the first calculation module 420 or the second calculation module 430. The calculated value acquired from the first calculation module 420 may include the composite score. The calculate value acquired from the second calculation module 430 may include an SNR value.

The display control module 440 may control the display brightness based on the calculated value. The display control module 440 may increase the display brightness. The display control module 440 may perform various methods for increasing the display brightness. A detailed description related to this configuration is provided with reference to FIG. 7.

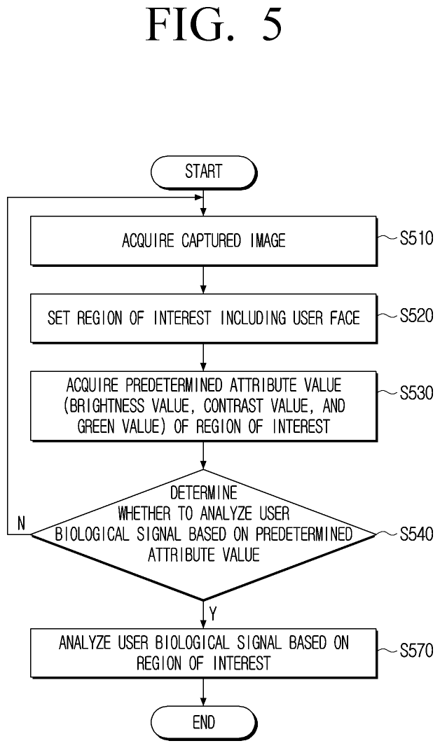

FIG. 5 is a flowchart for describing the operation for analyzing the biological signal by analyzing the captured image.

Referring to FIG. 5, the electronic device 100 may acquire the captured image (S510).

For example, the electronic device 100 may acquire the captured image by using the camera 190 included in the electronic device 100.

For example, the electronic device 100 may acquire the captured image by using the camera included in the external device. Only the operation for capturing the captured image may be performed by the external device, and other operations may be performed by the electronic device 100.

The electronic device 100 may set (or determine or identify) the region of interest including the user face (S520). The electronic device 100 may identify the human object from the captured image. If the human object is identified, the electronic device 100 may identify the face object from the human object. The electronic device 100 may determine the position corresponding to the face object as the region of interest.

The electronic device 100 may acquire the predetermined attribute value of the region of interest (S530). The predetermined attribute value may include at least one of the brightness value, the contrast value, the green value, or the SNR of the green value.

The electronic device 100 may determine whether to analyze the user biological signal based on the predetermined attribute value (S540). The electronic device 100 may determine whether the image data included in the region of interest is appropriate for the analysis. The reason is that result reliability may be reduced if the analysis is performed based on inappropriate image data. The electronic device 100 may calculate analysis appropriateness for the region of interest before performing the analysis.

The electronic device 100 may re-acquire the captured image if the user biological signal is identified as not being analyzed based on the predetermined attribute value (S540—N). The electronic device 100 may perform steps S510, S520, S530, and S540.

The electronic device 100 may analyze the user biological signal based on the region of interest (S570) if the user biological signal is identified as being analyzed based on the predetermined attribute value (S540—Y). The electronic device 100 may analyze the user biological signal based on the image data corresponding to the region of interest.

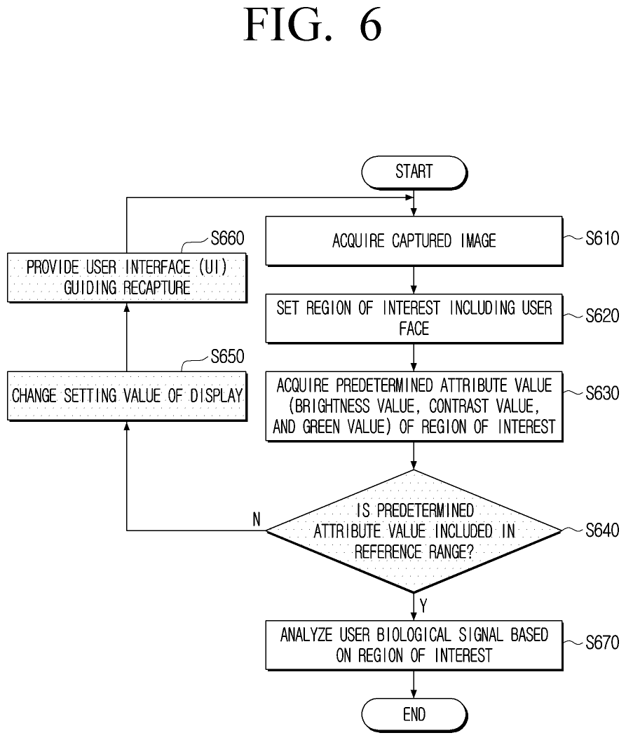

FIG. 6 is a flowchart for describing a recapture operation.

Steps S610, S620, S630, and S670 in FIG. 6 may correspond to steps S510, S520, S530, and S570 in FIG. 5. Therefore, redundant descriptions thereof are omitted.

After acquiring the predetermined attribute value, the electronic device 100 may identify whether the predetermined attribute value is included in the reference range (S640). The reference range may vary depending on an attribute value type. The reference range may vary depending on a user setting.

The electronic device 100 may change the setting value of the display (S650) if the predetermined attribute value is not included in the reference range (S640—N). An operation for changing the setting value of the display is described with reference to FIG. 7.

For example, the setting value of the display may indicate the setting value of the display 140 included in the electronic device 100.

For example, the setting value of the display may indicate the setting value of the display included in the external device. A control command may be transmitted to the external device if the setting value of the display included in the external device is to be changed.

After changing the setting value of the display, the electronic device 100 may provide the user interface (UI) guiding the recapture (S660). A detailed description related to the guide UI is described with reference to FIGS. 16 to 19. The user may attempt the analysis by using the recapture through the UI or the recaptured image.

For example, the electronic device 100 may provide a guide screen. The guide screen may be a guide UI displayed on the display.

For example, the electronic device 100 may provide a guide voice. The guide voice may be a guide UI output through the speaker.

The electronic device 100 may perform step S670 if the predetermined attribute value is included in the reference range (S640—Y).

FIG. 7 is a flowchart for describing an operation for increasing the display brightness.

Steps S710, S720, S730, S740, S750, S760, and S770 in FIG. 7 may correspond to steps S610, S620, S630, S640, S650, S660, and S670 in FIG. 6. Therefore, redundant descriptions thereof are omitted.

The electronic device 100 may increase the display brightness (S750) if the predetermined attribute value is not included in the reference range (S740—N). The electronic device 100 may use various methods to increase the display brightness.

For example, the electronic device 100 may increase a light source output that is output from the display (i.e., the first operation). The light source may indicate a light source of the display.

For example, the electronic device 100 may increase an RGB value output from the display (i.e., the second operation). The electronic device 100 may change the RGB value output from the display. The electronic device 100 may output a specific image on the display. The electronic device 100 may increase the RGB value of the specific image being output. The electronic device 100 may output the same image having an increased RGB value.

The electronic device 100 may increase the display brightness by adjusting the red value (or an R value), the green value (or a G value), and the blue value (or a B value), respectively. The electronic device 100 may increase the red value (or the R value) at a first rate, increase the green value (or the G value) at a second rate, and increase the blue value (or the B value) at a third rate.

The first rate, the second rate, and the third rate may be the same as one another.

One or more of the first rate, the second rate, and the third rate may be the same as each other.

The first rate and the second rate may be the same as each other. The second rate and the third rate may be the same as each other. The first rate and the third rate may be the same as each other.

The first rate, the second rate, and the third rate may all be different from one another.

For example, the electronic device 100 may output, to the display, a brighter image than an existing image (i.e., the third operation). The electronic device 100 may store a plurality of images (or test images) having different average brightness values. The electronic device 100 may identify a second image that is brighter than a first image (the existing output image). The electronic device 100 may determine the second image to be output to the display.

For example, the electronic device 100 may output the illumination (i.e., the fourth operation). The electronic device 100 may include an illumination output module. The illumination output module may be described as a light source output module. Although the display may output light sources of various colors, the illumination output module may be a module that outputs a white light source.

For example, the electronic device 100 may increase the green value (or the G value) output from the display (i.e., the fifth operation). The electronic device 100 may change the green value (or the G value) output from the display. The electronic device 100 may output a specific image on the display. The electronic device 100 may increase the green value (or the G value) of the specific image being output. The electronic device 100 may output the same image, and output an image having an increased green value (or the G value).

The electronic device 100 may increase the display brightness by using at least one of the various methods described above. Increasing the display brightness may make it easier to analyze the captured image.

After increasing the display brightness, the electronic device 100 may perform step S760.

FIG. 8 is a flowchart for describing an operation for comparing the illuminance values.

Steps S810, S820, S830, S840, S850, S860, and S870 in FIG. 8 may correspond to steps S610, S620, S630, S640, S650, S660, and S670 in FIG. 6. Therefore, redundant descriptions thereof are omitted.

After acquiring the captured image, the electronic device 100 may acquire the illuminance value (S815). The electronic device 100 may include the illuminance sensor. The electronic device 100 may acquire the sensing data by using the illuminance sensor. The electronic device 100 may acquire the illuminance value based on the sensing data.

The electronic device 100 may determine whether the illuminance value is greater than or equal to the first threshold value (S816). The reason is that the captured image analysis may become meaningless if the illuminance itself is low.

The electronic device 100 may perform steps S820, S830, S840, S850, S860, and S870 if the illuminance value is greater than or equal to the first threshold value (S816—Y).

The electronic device 100 may increase the display brightness (S850) and provide the UI guiding the recapture (S860) if the illuminance value is less than the first threshold value (S816—N). The electronic device 100 may perform steps S810, S815, and S816.

According to the various embodiments, steps S815 and S816 may be performed prior to the acquiring of the captured image (S810). The electronic device 100 may pre-determine whether the capture is appropriate by acquiring the illuminance value before acquiring the captured image.

FIG. 9 is a flowchart for describing an operation for comparing the brightness values.

Steps S910, S920, S930, S940, S950, S960, and S970 in FIG. 9 may correspond to steps S610, S620, S630, S640, S650, S660, and S670 in FIG. 6. Therefore, redundant descriptions thereof are omitted.

After setting the region of interest, the electronic device 100 may acquire the brightness value of the region of interest (S930).

The electronic device 100 may identify whether the brightness value is greater than or equal to the second threshold value (S940).

The electronic device 100 may increase the display brightness (S950) if the brightness value is not greater than or equal to the second threshold value (S940—N). After increasing the display brightness, the electronic device 100 may perform step S960.

The electronic device 100 may analyze the user biological signal based on the region of interest (S970) if the brightness value is greater than or equal to the second threshold value (S940—Y).

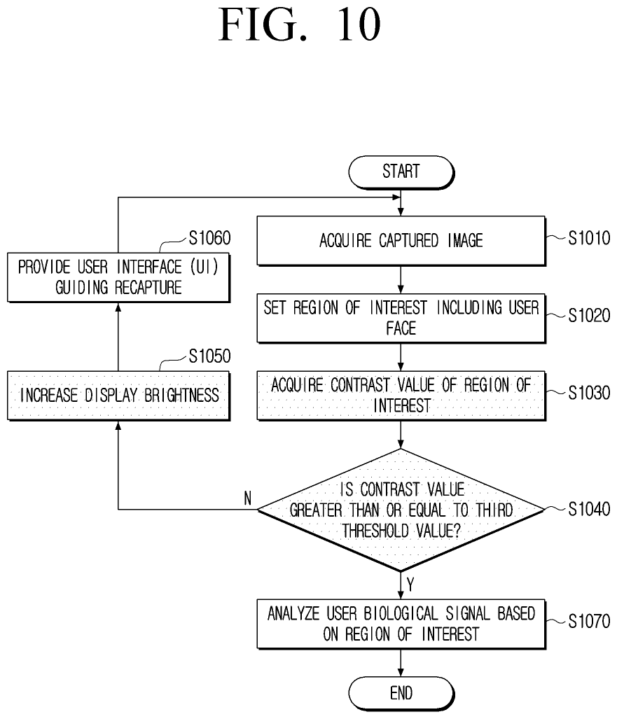

FIG. 10 is a flowchart for describing an operation for comparing the contrast values.

Steps S1010, S1020, S1030, S1040, S1050, S10100, and S1070 in FIG. 10 may correspond to steps S610, S620, S630, S640, S660, S660, and S670 in FIG. 6. Therefore, redundant descriptions thereof are omitted.

After setting the region of interest, the electronic device 100 may acquire the contrast value of the region of interest (S1030).

The electronic device 100 may identify whether the contrast value is greater than or equal to the third threshold value (S1040).

The electronic device 100 may increase the display brightness (S1050) if the contrast value is not greater than or equal to the third threshold value (S1040—N). After increasing the display brightness, the electronic device 100 may perform step S1060.

The electronic device 100 may analyze the user biological signal based on the region of interest (S1070) if the contrast value is greater than or equal to the third threshold value (S1040—Y).

FIG. 11 is a flowchart for describing an operation for comparing the brightness values and the contrast values.

Steps S1110, S1120, S1130, S1150, S1160, and S1170 in FIG. 11 may correspond to steps S610, S620, S630, S660, S660, and S670 in FIG. 6. Therefore, redundant descriptions thereof are omitted.

After setting the region of interest, the electronic device 100 may acquire the brightness value and contrast value of the region of interest (S1130).

The electronic device 100 may identify whether the brightness value is greater than or equal to the second threshold value (S1141).

The electronic device 100 may increase the display brightness (S1150) if the brightness value is not greater than or equal to the second threshold value (S1141—N). After increasing the display brightness, the electronic device 100 may perform step S1160.

The electronic device 100 may identify whether the contrast value is greater than or equal to the third threshold value (S1142) if the brightness value is greater than or equal to the second threshold value (S1141—Y).

The electronic device 100 may increase the display brightness (S1150) if the contrast value is not greater than or equal to the third threshold value (S1142—N). After increasing the display brightness, the electronic device 100 may perform step S1160.

The electronic device 100 may analyze the user biological signal based on the region of interest (S1170) if the contrast value is greater than or equal to the third threshold value (S1142—Y).

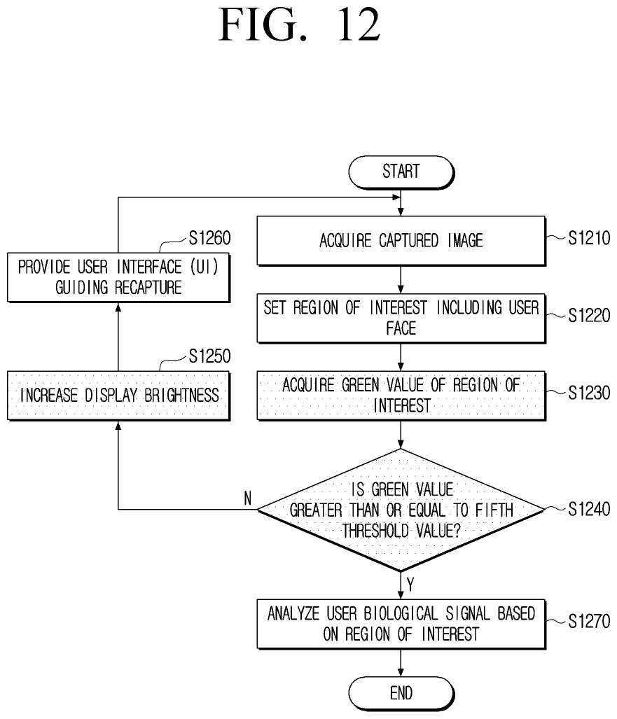

FIG. 12 is a flowchart for describing an operation for comparing the green values.

Steps S1210, S1220, S1230, S1240, S1250, S1260, and S1270 in FIG. 12 may correspond to steps S610, S620, S630, S640, S660, S660, and S670 in FIG. 6. Therefore, redundant descriptions thereof are omitted.

After setting the region of interest, the electronic device 100 may acquire the green value of the region of interest (S1230).

The electronic device 100 may identify whether the green value is greater than or equal to a fifth threshold value (S1240).

The electronic device 100 may increase the display brightness (S1250) if the green value is not greater than or equal to the fifth threshold value (S1240—N). After increasing the display brightness, the electronic device 100 may perform step S1260.

The electronic device 100 may analyze the user biological signal based on the region of interest (S1270) if the green value is greater than or equal to the fifth threshold value (S1240-Y).

FIG. 13 is a flowchart for describing an operation for comparing the signal-to-noise ratios (SNRs) of the green values.

Steps S1310, S1320, S1340, S1350, S1360, and S1370 in FIG. 13 may correspond to steps S610, S620, S640, S660, S660, and S670 in FIG. 6. Therefore, redundant descriptions thereof are omitted.

After setting the region of interest, the electronic device 100 may separate the red value, the green value, and the blue value of the region of interest from one another (S1331). The electronic device 100 may separate the color value of the region of interest into a predetermined color. The electronic device 100 may acquire the red value, the green value, and the blue value from the image data corresponding to the region of interest.

The electronic device 100 may perform a preprocessing operation on the red value, the green value, and the blue value, separated from one another. The preprocessing operation may indicate performing a normalization operation and a filtering operation.

The electronic device 100 may acquire the noise value based on the region of interest (S1132). The electronic device 100 may acquire the noise value based on the red value, the green value, and the blue value. The noise value may include a value identified as noise for a specific target color. In some implementation examples, step S1332 may be omitted.

The electronic device 100 may acquire the SNR of the green value of the region of interest (S1333). The electronic device 100 may acquire the SNR of the green value from the red value, the green value, the blue value, the noise value, or the like acquired from the image data corresponding to the region of interest. The target color may be the green value. The electronic device 100 may calculate the signal-to-noise ratio (SNR) of the target color.

The electronic device 100 may identify whether the SNR of the green value is greater than or equal to a fourth threshold value (S1340).

The electronic device 100 may increase the display brightness (S1350) if the SNR of the green value is not greater than or equal to the fourth threshold value (S1340—N). After increasing the display brightness, the electronic device 100 may perform step S1360.

The electronic device 100 may analyze the user biological signal based on the region of interest (S1370) if the SNR of the green value is greater than or equal to the fourth threshold value (S1340—Y).

FIG. 14 is a flowchart for describing an operation for comparing the brightness values, the contrast values, or the signal-to-noise ratios (SNRs) of the green values.

Steps S1410, S1420, S1430, S1450, S1460, and S1470 in FIG. 14 may correspond to steps S610, S620, S630, S660, S660, and S670 in FIG. 6. Therefore, redundant descriptions thereof are omitted.

After setting the region of interest, the electronic device 100 may acquire the brightness value, the contrast value, or the SNR of the green value of the region of interest (S1430).

The electronic device 100 may identify whether the brightness value is greater than or equal to the second threshold value (S1441).

The electronic device 100 may increase the display brightness (S1450) if the brightness value is not greater than or equal to the second threshold value (S1441—N). After increasing the display brightness, the electronic device 100 may perform step S1460.

The electronic device 100 may identify whether the contrast value is greater than or equal to the third threshold value (S1442) if the brightness value is greater than or equal to the second threshold value (S1441—Y).

The electronic device 100 may increase the display brightness (S1450) if the contrast value is not greater than or equal to the third threshold value (S1442—N). After increasing the display brightness, the electronic device 100 may perform step S1460.

The electronic device 100 may identify whether the SNR of the green value is greater than or equal to the fourth threshold value (S1443) if the contrast value is greater than or equal to the third threshold value (S1442—Y).

The electronic device 100 may increase the display brightness (S1450) if the SNR of the green value is not greater than or equal to the fourth threshold value (S1443—N). After increasing the display brightness, the electronic device 100 may perform step S1460.

The electronic device 100 may analyze the user biological signal based on the region of interest (S1470) if the SNR of the green value is greater than or equal to the fourth threshold value (S1443—Y).

According to the various embodiments, an order of steps S1441, S1442, and S1443 may be changed.

FIG. 15 is a flowchart for describing an operation for controlling a method for adjusting the display brightness differently depending on the attribute value type.

Steps S1510, S1520, S1530, S1541, S1542, S1543, S1560, and S1570 in FIG. 15 may correspond to steps S1410, S1420, S1430, S1441, S1442, S1443, S1460, and S1470 in FIG. 14. Therefore, redundant descriptions thereof are omitted.

The electronic device 100 may increase the display brightness by performing the first control operation (S1550) if the brightness value is not greater than or equal to the second threshold value (S1541—N).

The electronic device 100 may increase the display brightness by performing the first control operation (S1550) if the contrast value is not greater than or equal to the third threshold value (S1542—N).

The first control operation may include at least one of the first operation for increasing the light source output that is output from the display, the second operation for increasing the RGB value output from the display, the third operation for causing the electronic device 100 to output the brighter image than the existing image to the display, and the fourth operation for causing the electronic device 100 to output the illumination. A detailed description related to this configuration is described with reference to FIG. 7.

The electronic device 100 may increase the display brightness by performing the second control operation (S1550) if the SNR of the green value is not greater than or equal to the fourth threshold value (S1543—N).

The second control operation may include the fifth operation for increasing the green value (or the G value) output from the display. A detailed description related to this configuration is described with reference to FIG. 7.

After increasing the display brightness, the electronic device 100 may perform step S1560.

According to the various embodiments, the first operation, the second operation, the third operation, the fourth operation, and the fifth operation may be included in at least one of the first control operation or the second control operation.

FIG. 16 is a view for describing a screen for guiding the recapture.

A screen 1600 in FIG. 16 may include at least one of a background region 1610, an application title region 1620, an image region 1630, a first notification region 1640, or a second notification region 1650.

The background region 1610 may indicate a region where the background color is displayed. The background region 1610 may display the predetermined color or the predetermined image.

The application title region 1620 may be a region where the title of an application for analyzing the biological signal is displayed.

The image region 1630 may be a region where the captured image is displayed in real time, or where an image that is already captured is displayed.

The first notification region 1640 may be a region where whether the captured image is appropriate for the analysis is displayed.

The second notification region 1650 may be a region that includes information that guides the recapture.

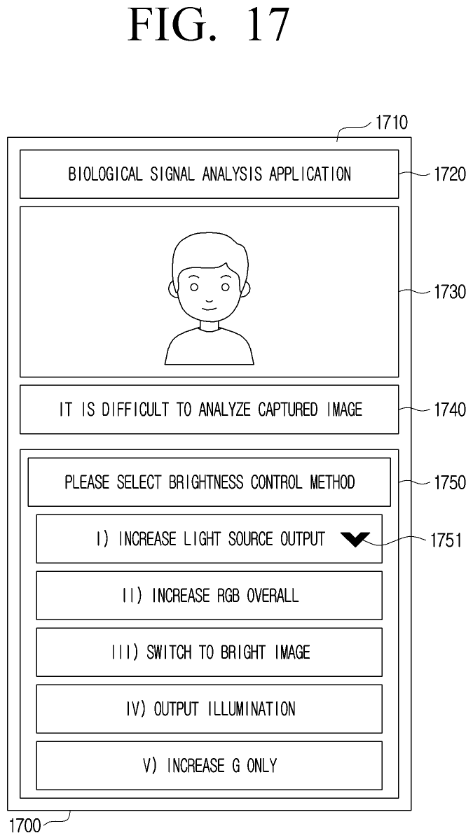

FIG. 17 is a view for describing a screen for selecting a brightness adjustment method.

A screen 1700 in FIG. 17 may include at least one of a background region 1710, an application title region 1720, an image region 1730, a first notification region 1740, or a second notification region 1750.

The background region 1710, the application title region 1720, the image region 1730, and the first notification region 1740 in FIG. 17 may correspond to the background region 1610, the application title region 1620, the image region 1630, and the first notification region 1640 in FIG. 16. Therefore, redundant descriptions thereof are omitted.

The second notification region 1750 may be a region where the method for adjusting the display brightness is displayed. In the second notification region 1750, the first control operation may include at least one of the first operation for increasing the light source output from the display, the second operation for increasing the RGB value output from the display, the third operation for causing the electronic device 100 to output the brighter image than the existing image to the display, the fourth operation for causing the electronic device 100 to output the illumination, or the fifth operation for increasing the green value (or the G value) output from the display. A detailed description related to this configuration is provided with reference to FIG. 7.

The second notification region 1750 may include a UI 1751 indicating items selected by the user. The electronic device 100 may increase the display brightness based on the selected item if one of the plurality of items is selected by the user.

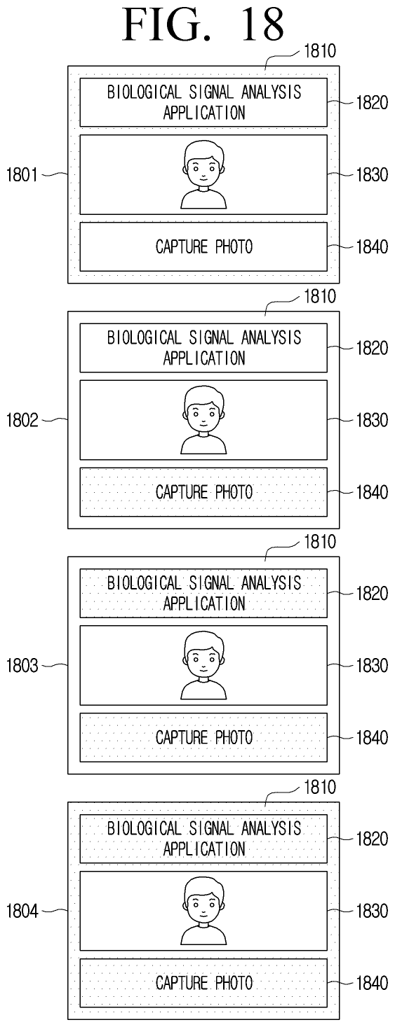

FIG. 18 is a view for describing a brightness adjustment region.

Screens 1801, 1802, 1803, and 1804 in FIG. 18 may include at least one of a background region 1810, an application title region 1820, an image region 1830, or a first notification region 1840.

The background region 1810, the application title region 1820, the image region 1830, and the first notification region 1840 in FIG. 18 may correspond to the background region 1610, the application title region 1620, the image region 1630, and the first notification region 1640 in FIG. 16. Therefore, redundant descriptions thereof are omitted.

The electronic device 100 may perform the operation for increasing the display brightness. The operation for increasing the display brightness may be applied to a predetermined region. The electronic device 100 may increase the brightness of the predetermined region.

The predetermined region may be a region where the brightness is adjusted. The predetermined region may be described as the brightness adjustment region. The brightness adjustment region may vary depending on the user setting. The brightness adjustment region may be at least one region.

On the screen 1801, the brightness adjustment region may be the background region 1810. The electronic device 100 may increase the display brightness of the background region 1810.

On the screen 1802, the brightness adjustment region may be the first notification region 1840. The electronic device 100 may increase the display brightness of the first notification region 1840.

On the screen 1803, the brightness adjustment region may be the application title region 1820 or the first notification region 1840. The electronic device 100 may increase the display brightness of the application title region 1820 or the first notification region 1840.

On the screen 1803, the brightness adjustment region may be the background region 1810, the application title region 1820, or the first notification region 1840. The electronic device 100 may increase the display brightness of the background region 1810, the application title region 1820, or the first notification region 1840.

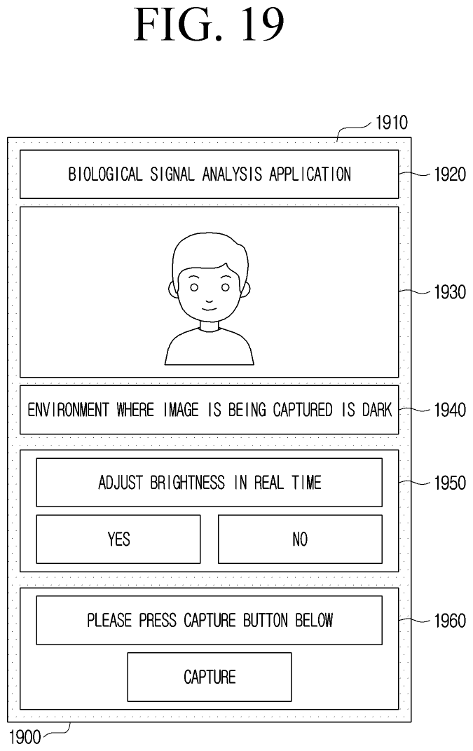

FIG. 19 is a view for describing a screen on which the brightness is adjusted in a real-time capture stage.

A screen 1900 in FIG. 19 may include at least one of a background region 1910, an application title region 1920, an image region 1930, a first notification region 1940, a second notification region 1950, or a third notification region 1960.

The background region 1910, the application title region 1920, the image region 1930, and the first notification region 1940 in FIG. 19 may correspond to the background region 1610, the application title region 1620, the image region 1630, and the first notification region 1640 in FIG. 16. Therefore, redundant descriptions thereof are omitted.

The image region 1930 may be a region where an image being captured in real time is displayed. The image region 1930 may include an image that is currently being captured, not a still image. Therefore, if the user moves, the image region 1930 may display the moving user in real time.

The first notification region 1940 may be a region indicating whether the image currently being captured in real time is appropriate for the biological signal analysis. The first notification region 1940 may include information indicating whether a current capture environment is appropriate. The first notification region 1940 may include information indicating that the current capture environment is appropriate or information indicating that the current capture environment is inappropriate.

The second notification region 1950 may include guidance information for adjusting the display brightness in real time. The electronic device 100 may increase the display brightness if the user input is received through the second notification region 1950.

For example, the electronic device 100 may increase the display brightness of the background region 1910. In some implementation examples, a region where the display brightness is increased may vary depending on the user setting.

The third notification region 1960 may be a region where a capture command is received. The electronic device 100 may perform the capture command if the user input is received through the third notification region 1960. The electronic device 100 may acquire the image being captured in the image region 1930 as the captured image if the capture command is performed.

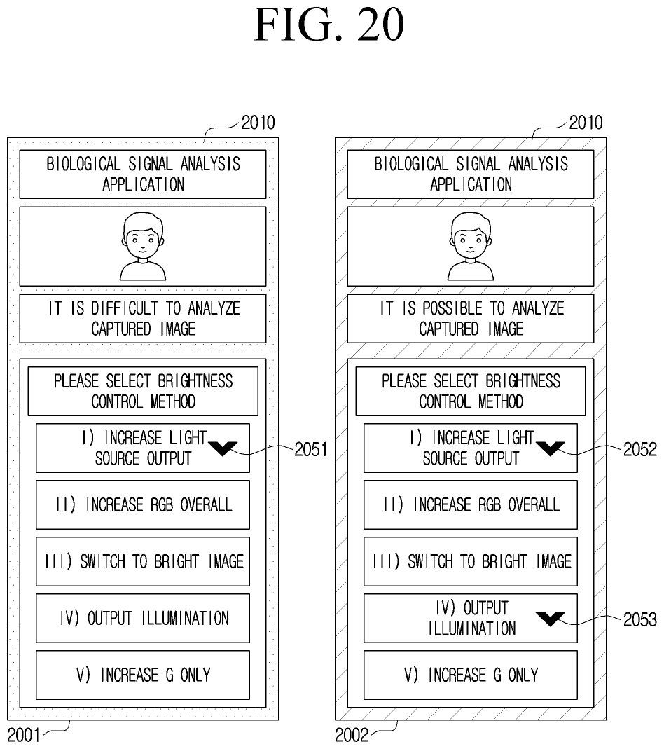

FIG. 20 is a view for describing an operation for selecting a plurality of brightness adjustment methods.

A screen 2001 in FIG. 20 may be a screen displayed in a case where only one brightness adjustment method is selected. The screen 2001 may display a UI 2051 indicating a method selected by the user among the plurality of methods. The electronic device 100 may output display brightness of the background region 2010 as the first brightness value.

The plurality of brightness adjustment methods may be selected by the user.

A screen 2002 in FIG. 20 may be a screen displayed in a case where only one of the brightness adjustment methods is selected. The screen 2002 may display UIs 2052 and 2053 indicating a plurality of methods selected by the user among the plurality of methods. The electronic device 100 may output the display brightness of the background region 2010 as the second brightness value. If the user simultaneously selects the plurality of methods, the electronic device 100 may control the display based on the second brightness value that is greater than the first brightness value.

If three items are selected, the electronic device 100 may control the display based on the third brightness value that is greater than the second brightness value.

At least one of the operations of the electronic device 100 described above may be performed by another device.

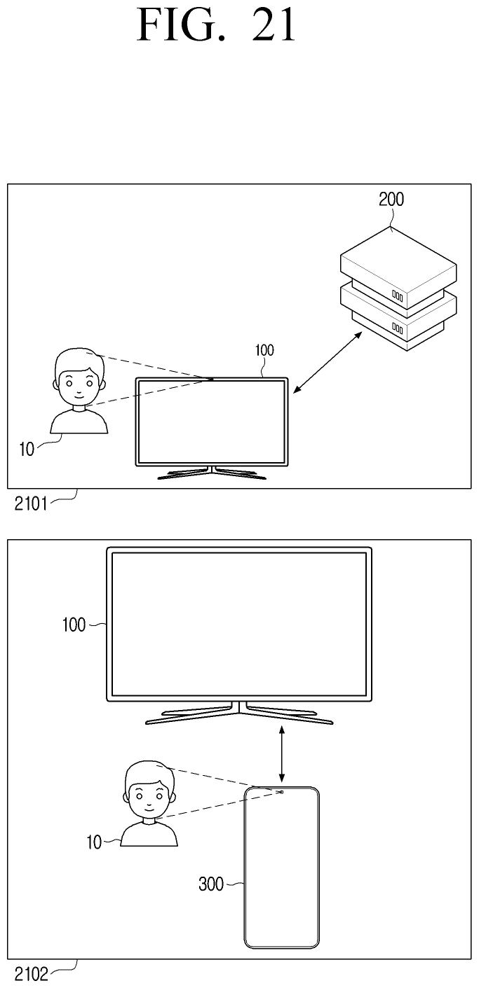

FIG. 21 is a view for describing the image analysis operation by using a plurality of devices.

Referring to Embodiment 2101 in FIG. 21, the electronic device 100 and the server 200 may perform operations for analyzing the biological signal. The plurality of operations performed for analyzing the biological signal may be performed by the electronic device 100 and the server 200. For example, the electronic device 100 may perform the capture operation and the operation for increasing the display brightness. The server 200 may perform a calculation operation and an analysis operation.

Referring to Embodiment 2102 in FIG. 21, the electronic device 100 and the external device 300 may perform the operations for analyzing the biological signal. The plurality of operations for analyzing the biological signal may be performed by the electronic device 100 and the external device 300. For example, the electronic device 100 may perform the capture operation and the operation for increasing the display brightness. The external device 300 may perform the calculation operation and the analysis operation.

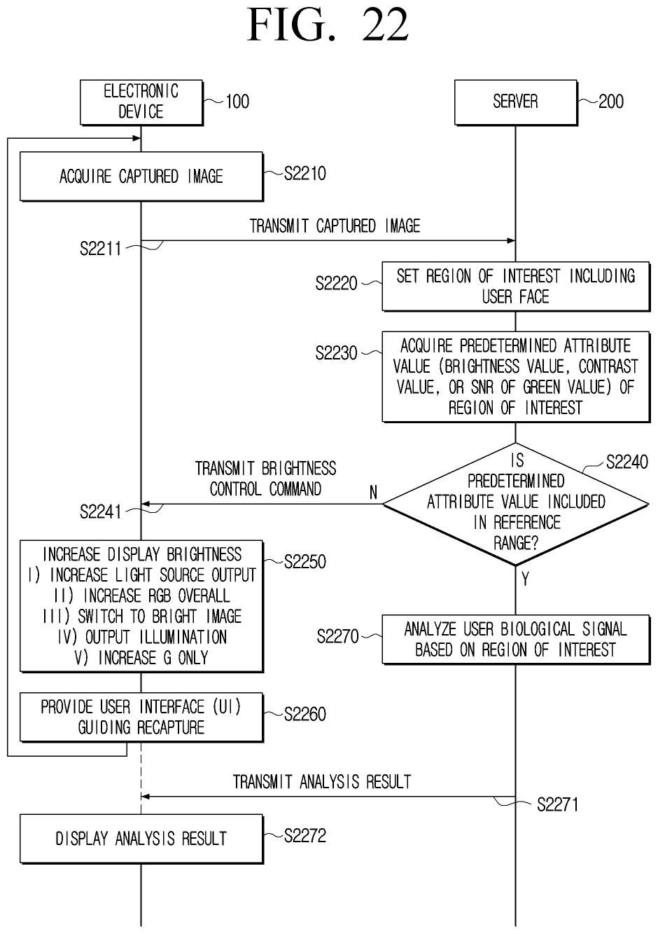

FIG. 22 is a flowchart for describing the image analysis operation by the server 200.

Steps S2210, S2220, S2230, S2240, S2250, S2260, and S2270 in FIG. 22 may correspond to steps S610, S620, S630, S640, S660, S660, and S670 in FIG. 6. Therefore, redundant descriptions thereof are omitted.

The electronic device 100 may acquire the captured image (S2210). The electronic device 100 may transmit the captured image to the server 200 (S2211).

The server 200 may receive the captured image from the electronic device 100. The server 200 may set the region of interest including the user face based on the captured image (S2220).

The server 200 may acquire the predetermined attribute value of the region of interest (S2230). The server 200 may determine whether the predetermined attribute value is included in the reference range (S2240).

The server 200 may transmit a brightness control command to the electronic device 100 (S2241) if the predetermined attribute value is not included in the reference range (S2240-N)

The electronic device 100 may receive the brightness control command from the server 200. The electronic device 100 may perform the operation for increasing the display brightness based on the brightness control command (S2250). The electronic device 100 may provide the UI guiding the recapture (S2260). The electronic device 100 may perform the recapture operation. After the capture operation, the S2210, S2211, S2220, S2230, and S2240 operations may be performed.

The server 200 may analyze the user biological signal based on the region of interest (S2270) if the predetermined attribute value is included in the reference range (S2240—Y). The server 200 may transmit the analysis result to the electronic device 100 (S2271).

The electronic device 100 may receive the analysis result from the server 200. The electronic device 100 may display the analysis result (S2272).

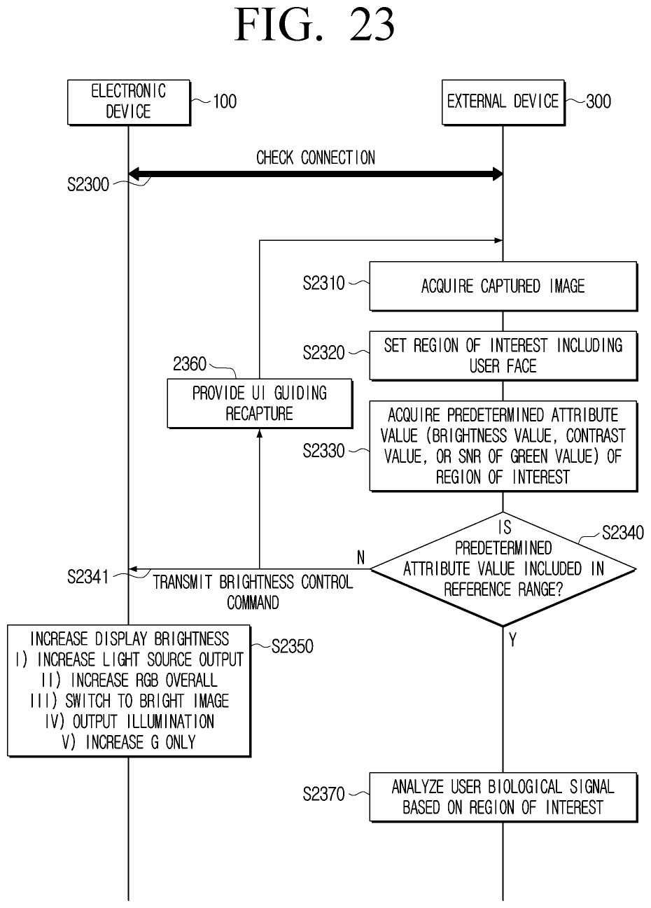

FIG. 23 is a flowchart for describing the image analysis operation by an external device 300.

Steps S2310, S2320, S2330, S2340, S2350, S2360, and S2370 in FIG. 23 may correspond to steps S610, S620, S630, S640, S660, S660, and S670 in FIG. 6. Therefore, redundant descriptions thereof are omitted.

The electronic device 100 may be a general display device, and the external device 300 may include the user terminal device. For example, the electronic device 100 may be a TV, and the external device 300 may be a smart device. The smart device may include a smartphone, a smart watch, a wearable device, a tablet, or the like.

The electronic device 100 and the external device 300 may perform a communication connection therebetween. The electronic device 100 and the external device 300 may check whether the devices are connected to each other (S2300).

After the connection, the external device 300 may acquire the captured image (S2310). The external device 300 may set the region of interest including the user face (S2320).

The external device 300 may set the region of interest including the user face based on the captured image (S2320).

The external device 300 may acquire the predetermined attribute value of the region of interest (S2330). The external device 300 may determine whether the predetermined attribute value is included in the reference range (S2340).

The external device 300 may transmit the brightness control command to the electronic device 100 (S2341) if the predetermined attribute value is not included in the reference range (S2340—N).

The electronic device 100 may receive the brightness control command from the external device 300. The electronic device 100 may perform the operation for increasing the display brightness based on the brightness control command (S2350).

The external device 300 may provide the UI guiding the recapture (S2360) if the predetermined attribute value is not included in the reference range (S2340—N). The external device 300 may perform the recapture operation. After the capture operation, the S2310, S2320, S2330, and S2340 operations may be performed.

The external device 300 may analyze the user biological signal based on the region of interest (S2370) if the predetermined attribute value is included in the reference range (S2340-Y).

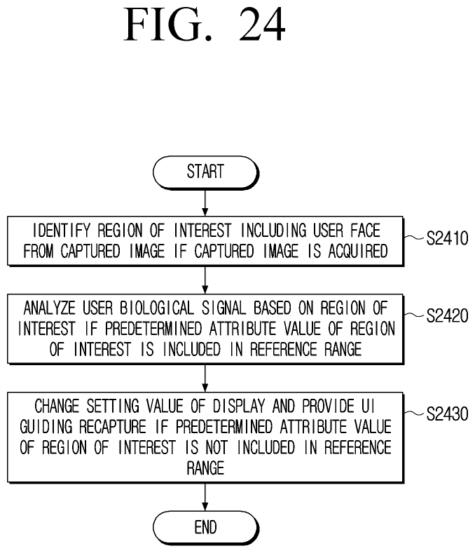

FIG. 24 is a flowchart for describing a control method of an electronic device 100 according to an embodiment.

Referring to FIG. 24, the control method of an electronic device including a display may include: identifying the region of interest including the user face from the captured image if the captured image is acquired (S2410); analyzing the user biological signal based on the region of interest if the predetermined attribute value of the region of interest is included in the reference range (S2420); and changing the setting value of the display and providing the UI guiding the recapture if the predetermined attribute value of the region of interest is not included in the reference range (S2430).

In the changing of the setting value of the display, the display may be controlled to increase the brightness of the display by changing the setting value of the display.

In the changing of the setting value of the display, the display may be controlled to increase the brightness of the background region included in the UI guiding the recapture.

The control method may further include: acquiring the illuminance value from the sensing data acquired using the illuminance sensor of the electronic device; and changing the setting value of the display if the illuminance value is less than the first threshold value.

The control method may further include acquiring the predetermined attribute value from the image data corresponding to the region of interest, the predetermined attribute value including at least one of the brightness value, the contrast value, the green value, or the signal-to-noise ratio (SNR) of the green value.

The control method may further include: acquiring the brightness value corresponding to the region of interest; and changing the setting value of the display based on the first control operation if the brightness value is less than the second threshold value.

The first control operation may include at least one of the operation for increasing the light source output value of the display, the operation for increasing the RGB value output from the display, the operation for switching the output image, and the operation for outputting the illumination.

The control method may further include: acquiring the contrast value corresponding to the region of interest; determining whether the contrast value is greater than or equal to the third threshold value if the brightness value is greater than or equal to the second threshold value; and changing the setting value of the display based on the first control operation if the contrast value is less than the third threshold value.

The control method may further include: acquiring the signal-to-noise ratio (SNR) of the green value corresponding to the region of interest; and changing the setting value of the display based on the second control operation if the signal-to-noise ratio (SNR) of the green value is less than the fourth threshold value.

The second control operation may include the operation of increasing the green value output from the display.

FIG. 25 is a flowchart for describing an operation for determining the target color value and the target luminance value according to an embodiment.

Referring to FIG. 25, the electronic device 100 may apply settings related to an image sensor (e.g., the camera) (S2505). The electronic device 100 may apply the settings related to the image sensor. The settings related to the image sensor may include settings necessary for detecting the brightness and the background color required for the rPPG measurement. For example, the settings related to the image sensor may include at least one of a white balance setting or an exposure setting (or an exposure value setting). The electronic device 100 may perform the capture operation by using the image sensor based on predetermined setting information.

The electronic device 100 may acquire the captured image based on the predetermined setting information (information set in step S2505) (S2510).

The electronic device 100 may acquire (or identify) the region of interest (ROI) related to the user face from the captured image (S2515). The electronic device 100 may identify the user face from the captured image. The electronic device 100 may identify the region of interest based on a predetermined reference (or the object). For example, the region of interest may include a region representing at least one of a user forehead or a user cheek. This configuration is described with reference to FIG. 29.

The electronic device 100 may acquire the user skin color information based on the region of interest (S2520). The electronic device 100 may store the color value of the region of interest for the predetermined time. The color value may include at least one of the R value, the G value, or the B value.

For example, the electronic device 100 may store the color value R, G, and B including all the R value, G value, and B value for the predetermined time.

The electronic device 100 may acquire an average color value based on the color value of the region of interest stored for the predetermined time. The electronic device 100 may acquire (or identify or estimate) the skin color information based on the average color value.

The electronic device 100 may determine the skin color information based on a predefined Fitzpatrick scale. The skin color information may include at least one of a color value of the skin color or a type of the skin color. The electronic device 100 may determine the type of the skin color. A predefined type may be provided based on the skin color. For example, six types may be defined with respect to the skin color. The skin color may be classified into a first type to a sixth type. The first type may correspond to the brightest tone and the sixth type may correspond to the darkest tone. The electronic device 100 may determine the type of the skin color based on the average color value (or the skin color).

The electronic device 100 may acquire the luminance range and the color range based on the user skin color information (S2525). The electronic device 100 may acquire brightness information corresponding to the skin color information. The electronic device 100 may acquire background color information corresponding to the skin color information. The brightness information may include the luminance range. The background color information may include the color range.

The electronic device 100 may pre-store the skin color-luminance range table (or the first table) representing the luminance range corresponding to each of the plurality of skin color types. The electronic device 100 may acquire the luminance range corresponding to the skin color type based on the first table.

For example, in the first table, the first type may correspond to a luminance range of 300 to 350 nits, and the sixth type may correspond to a luminance range of 800 to 900 nits.

The electronic device 100 may pre-store the skin color-color range table (the second table) representing the color range corresponding to each of the plurality of skin color types. The electronic device 100 may acquire the color range corresponding to the skin color type based on the second table. Based on the skin color, a range of the background color (e.g., green) that assists in the rPPG measurement accuracy may vary depending on the brightness. The color range may represent a brightness range. The color range may represent the brightness range representing one color. The color range may be described as a brightness range or a range of brightness of the background color.

For example, in the second table, the first type may have a relatively high brightness range. The high brightness range may be a range representing a bright brightness. The sixth type may have a relatively low brightness range. The low brightness range may be a range representing a dark brightness.

The electronic device 100 may perform step S2605 in FIG. 26 if the luminance range and the color range are acquired.

FIG. 26 is a flowchart for describing an operation for determining the target color value and the target luminance value according to an embodiment.

Referring to FIG. 26, after the step S2525 in FIG. 25 is performed, the electronic device 100 may apply a minimum brightness value within the luminance range (S2605). The electronic device 100 may set the display brightness to the minimum brightness value within the luminance range. The display brightness may be changed.

The electronic device 100 may identify whether output of all the background colors is completed (S2610). The output of the background colors may include an operation for outputting all brightness values associated with a color (the background color).

The electronic device 100 may perform a step S2805 in FIG. 28 if the output of all the background colors is completed (S2610—Y).

The electronic device 100 may acquire the first brightness value of the region of interest (S2615) if the output of all the background colors is not completed (S2610—N). The first brightness value may be value acquired from the captured image. The electronic device 100 may acquire the new captured image and acquire the first brightness value from the acquired captured image.

The electronic device 100 may change the color value of the background image (S2620). The electronic device 100 may change the brightness of the background color.

After the color value of the background image is changed, the electronic device 100 may acquire the second brightness value of the region of interest (S2625). The electronic device 100 may acquire the second brightness value from the captured image. The electronic device 100 may acquire the new captured image and acquire the second brightness value from the acquired captured image.

The electronic device 100 may determine whether the second brightness value exceeds the first brightness value (S2630). According to the various embodiments, the operation in S2630 may be replaced with an operation for determining whether the second brightness value exceeds the threshold value.

The electronic device 100 may identify whether the display brightness is the maximum within the luminance range (S2640) if the second brightness value does not exceed the first brightness value (S2630—N).

The electronic device 100 may repeat the steps S2605 to S2640 if the display has the maximum luminance value within the luminance range (S2640—Y).

The electronic device 100 may increase display luminance (S2645) if the display does not have the maximum luminance value within the luminance range (S2640—N). The electronic device 100 may repeat the steps S2625 to S2640 if the display has an increased luminance.

The electronic device 100 may acquire a first SNR of the green channel in the region of interest (S2635) if the second brightness value exceeds the first brightness value (S2630—Y).

The green channel may resemble the form of a photoplethysmogram (PPG) signal more than a red channel or a blue channel. The signal-to-noise ratio (SNR) may be used to examine signal quality. The electronic device 100 may store a green channel value among pixel values R, G, and B in the region of interest for the predetermined time. The electronic device 100 may acquire (or calculate) an average value of the green channel values for the predetermined time. The electronic device 100 may store these average values continuously for the predetermined time. The electronic device 100 may remove noise included in data (or the average value) by applying a moving average filter while storing the average values.

The moving average filter may be expressed as X\hat{ }_k={(X_k−n+1)+(X_k−n+2)+ . . . + (X_k)}/n.

k may represent a current time.

n may represent a window size.

X\hat{ }_k may represent a filtered result value at the current time k.

X_k may represent the data (or the average value) at the current time k

The electronic device 100 may convert the noise-removed data (or the average value) into a signal. The electronic device 100 may perform the preprocessing operation on the converted signal by using normalization and a band-pass filter. The electronic device 100 may acquire signal information in a frequency region by inputting the pre-processed signal into a fast Fourier transform (FFT) function. The electronic device 100 may acquire the first SNR based on the signal information in the frequency region.

After acquiring the first SNR, the electronic device 100 may perform step S2705 in FIG. 27.

FIG. 27 is a flowchart for describing an operation for determining the target color value and the target luminance value according to an embodiment.

Referring to FIG. 27, after performing step S2635 in FIG. 26, the electronic device 100 may determine whether the first SNR exceeds the threshold value (S2705). The threshold value may vary depending on the user setting.

The electronic device 100 may change the luminance range and/or the color range (S2710) if the first SNR does not exceed the threshold value (S2705—N). The electronic device 100 may determine that a current display output is not appropriate for the rPPG.

The electronic device 100 may identify whether the first SNR exceeds a pre-stored maximum SNR (S2715) if the first SNR exceeds the threshold value (S2705—Y).

The electronic device 100 may change the luminance range and/or the color range (S2710) if the first brightness value does not exceed the pre-stored maximum SNR (S2715—N). The electronic device 100 may determine that a more appropriate output setting exists than a current display output setting.

The electronic device 100 may update the maximum SNR to the first SNR (S2720) if the first brightness value exceeds the pre-stored maximum SNR (S2715—Y). The electronic device 100 may store the first SNR as the maximum SNR if the maximum SNR does not exist.

The electronic device 100 may store the target luminance value and the target color value used to acquire the first SNR (S2725). The target luminance value may include the brightness value of the display. The target color value may include the color value of the image displayed on the display. After step S2725, the electronic device 100 may change the luminance range and/or the color range (S2710).

The electronic device 100 may perform step S2605 in FIG. 26 to change the luminance range and/or the color range based on step S2710. The electronic device 100 may change the luminance value of the display based on step S2605 or S2645 in FIG. 26. The electronic device 100 may change the color value of the background image based on step S2620.

According to the various embodiments, step S2715 may be replaced by an operation for determining whether both the first SNR exceeds the pre-stored maximum SNR and the first brightness value exceeds a pre-stored maximum brightness value. Step S2720 may further include an operation for updating the maximum brightness value to the first brightness value.

FIG. 28 is a flowchart for describing an operation for determining the target color value and the target luminance value according to an embodiment.

The electronic device 100 may check whether the target luminance value and the target color value are stored (S2805) if the output of all the background colors is identified as being completed based on step S2610 in FIG. 26.

The electronic device 100 may output the guide UI (S2810) if the target luminance value and the target color value are not stored (S2805—N). The guide UI may include information indicating that the rPPG measurement is difficult. The guide UI may include information indicating that the environment is not appropriate for the rPPG measurement. The guide UI may include information guiding to change surrounding illumination. For example, the guide UI may include information guiding to change the illumination to brighter.

The electronic device 100 may control the display based on the target luminance value and the target color value (S2815) if the target luminance value and the target color value are stored (S2805—Y). The electronic device 100 may start the rPPG measurement based on the target luminance value and the target color value (S2820). The electronic device 100 may acquire an rPPG result (S2825).

The rPPG may be described as the biological signal analysis.

The target luminance value and the target color value may be the most effective settings for the rPPG measurement. The rPPG result may be stable and the accuracy may be a measurement result.

FIG. 29 is a view for describing the region of interest.

Referring to FIG. 29, the electronic device 100 may identify the user face object from the captured image. The electronic device 100 may identify a feature object included in the face object from the captured image. The feature object may include the landmark representing the user face. For example, the feature object may include at least one of an eye, a lip, a nose, or an eyebrow.

The electronic device 100 may acquire position information (or coordinate information) indicating a position of the feature object. The electronic device 100 may identify the region of interest based on the feature object. The region of interest may be a region indicating the user forehead or a region indicating the user cheek. The region of interest may include a plurality of regions. The electronic device 100 may identify the region of interest based on the position information of the feature object. The region of interest may be described as region of interest information. The region of interest information may include position information (or coordinate information) of the region of interest.

For example, the electronic device 100 may acquire the region of interest information of the user 10 including at least one of a first region of interest 2910, a second region of interest 2920, or a third region of interest 2930.

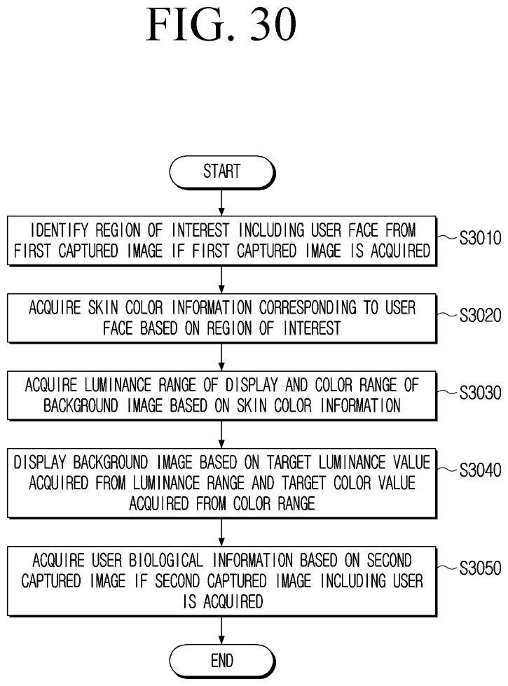

FIG. 30 is a flowchart for describing a control method of an electronic device according to an embodiment.

Referring to FIG. 30, the control method of an electronic device including a display for displaying a background image may include: identifying the region of interest including the user face from the first captured image if the first captured image is acquired (S3010); acquiring the skin color information corresponding to the user face based on the region of interest (S3020); acquiring the luminance range of the display and the color range of the background image based on the skin color information (S3030); displaying the background image based on the target luminance value acquired from the luminance range and the target color value acquired from the color range (S3040); and acquiring the user biological information based on the second captured image if the second captured image including the user is acquired after the background image is displayed (S3050).

In the acquiring of the user biological information (S3050), the second captured image may be acquired while the background image is displayed, the region of interest including the user face may be identified from the second captured image, and the user biological information may be acquired based on the region of interest.

In the acquiring of the user biological information (S3050), the background image may be displayed for the predetermined time based on the target luminance value and the target color value, the plurality of captured images may be acquired for the predetermined time, and the user biological information may be a value acquired from the color value of the region of interest included in each of the plurality of captured images.

The biological information may include at least one of the blood flow information or the heartbeat information.

The control method may further include: displaying the first background image based on the first luminance value corresponding to the minimum luminance value within the luminance range and the first color value within the color range; and acquiring the second captured image; and acquiring the target luminance value and the target color value from the second captured image if the second captured image is acquired after the first background image is displayed.

In the acquiring of the target luminance value and the target color value, the first brightness value of the region of interest may be a value acquired from the second captured image, the second background image may be displayed based on the first luminance value and the second color value that is different from the first color value, and the target luminance value and the target color value may be acquired from the third captured image if the third captured image including the user is acquired after the second background image is displayed based on the first luminance value.

In the acquiring of the target luminance value and the target color value, the second brightness value of the region of interest may be acquired from the third captured image, the signal-to-noise ratio (SNR) corresponding to the green channel may be acquired from the region of interest in the third captured image if the second brightness value exceeds the first brightness value, and the target luminance value and the target color value may be acquired based on the signal-to-noise ratio (SNR).

In the acquiring of the target luminance value and the target color value, the first luminance value may be changed to the second luminance value if the second brightness value does not exceed the first brightness value, the second background image may be displayed based on the second luminance value and the second color value, the third brightness value of the region of interest may be acquired from the fourth captured image if the fourth captured image including the user is acquired after the second background image is displayed based on the second luminance value, the signal-to-noise ratio (SNR) corresponding to the green channel may be acquired from the region of interest in the fourth captured image if the third brightness value exceeds the first brightness value, and the target luminance value and the target color value may be acquired based on the signal-to-noise ratio (SNR).

In the acquiring of the target luminance value and the target color value, whether the signal-to-noise ratio (SNR) exceeds the pre-stored maximum signal-to-noise ratio (SNR-max) may be determined if the signal-to-noise ratio (SNR) exceeds the threshold value, the pre-stored maximum signal-to-noise ratio (SNR-max) may be updated to the signal-to-noise ratio (SNR) if the signal-to-noise ratio (SNR) exceeds the pre-stored maximum signal-to-noise ratio (SNR-max), the luminance value used to acquire the signal-to-noise ratio (SNR) may be acquired as the target luminance value, and the color value used to acquire the signal-to-noise ratio (SNR) may be acquired as the target color value.

In the acquiring of the target luminance value and the target color value, the third background image may be displayed based on the first luminance value and the third color value that is different from the second color value if the signal-to-noise ratio (SNR) does not exceed the threshold value, and the target luminance value and the target color value may be acquired from the fifth captured image including the user after the third background image is displayed based on the first luminance value.

Meanwhile, the methods according to the various embodiments of the present disclosure described above may be implemented in the form of an application capable of being installed on a conventional electronic device.

In addition, the methods according to the various embodiments of the present disclosure described above may be implemented only by software upgrade or hardware upgrade of the conventional electronic device.

In addition, the various embodiments of the present disclosure described above may be performed through an embedded server included in the electronic device, or at least one external server of the electronic device or the display device.

Meanwhile, according to an embodiment of the present disclosure, the various embodiments described above may be implemented in software including an instruction stored on a machine-readable storage medium (for example, a computer-readable storage medium). A machine may be a device that invokes the stored instruction from a storage medium, may be operated based on the invoked instruction, and may include the electronic device according to the disclosed embodiments. If the instruction is executed by the processor, the processor may directly perform a function corresponding to the instruction or other components may perform the function corresponding to the instruction under control of the processor. The instruction may include codes provided or executed by a compiler or an interpreter. The machine-readable storage medium may be provided in the form of a non-transitory storage medium. Here, the term “non-transitory” indicates that the storage medium is tangible without including a signal, and does not distinguish whether data are semi-permanently or temporarily stored on the storage medium.

In addition, according to an embodiment, the methods according to the various embodiments described above may be included and provided in a computer program product. The computer program product may be traded as a commodity between a seller and a purchaser. The computer program product may be distributed in a form of the machine-readable storage medium (for example, a compact disc read only memory (CD-ROM)), or may be distributed online through an application store (for example, PlayStore™). In case of the online distribution, at least a part of the computer program product may be at least temporarily stored or temporarily provided on a storage medium such as the memory of a manufacturer server, an application store server, or a relay server.

In addition, each of the components (for example, modules or programs) according to the various embodiments described above may include a single entity or a plurality of entities, and some of the corresponding sub-components described above may be omitted or other sub-components may be further included in the various embodiments. Alternatively or additionally, some of the components (for example, the modules or the programs) may be integrated into the single entity, and may perform functions performed by the respective corresponding components before being integrated in the same or similar manner. Operations performed by the modules, the programs, or other components according to the various embodiments may be executed in a sequential manner, a parallel manner, an iterative manner, or a heuristic manner, at least some of the operations may be performed in a different order or be omitted, or other operations may be added.

Although the embodiments are shown and described in the present disclosure as above, the present disclosure is not limited to the above-described specific embodiments, and may be variously modified by those skilled in the art to which the present disclosure pertains without departing from the gist of the present disclosure as claimed in the accompanying claims. These modifications should also be understood to fall within the scope and spirit of the present disclosure.

1. An electronic device comprising:
a display;
a memory to store a background image; and
at least one processor configured to:
identify a region of interest including a user face from a first captured image acquired,
acquire skin color information corresponding to the user face based on the region of interest,
acquire a luminance range of the display and a color range of the background image based on the skin color information,
control the display to display the background image based on a target luminance value acquired from the luminance range and a target color value acquired from the color range, and
acquire user biological information based on a second captured image, which includes the user face of the first captured image, being acquired after the background image is displayed.

2. The electronic device as claimed in claim 1, wherein the at least one processor is configured to:
acquire the second captured image while the background image is displayed,
identify the region of interest including the user face from the second captured image, and
acquire the user biological information based on the region of interest.

3. The electronic device as claimed in claim 2, wherein the at least one processor is configured to:
control the display to display the background image for a predetermined time based on the target luminance value and the target color value, and
acquire the user biological information based on a color value of the region of interest included in a plurality of captured images acquired for the predetermined time.

4. The electronic device as claimed in claim 1, wherein the user biological information includes at least one of blood flow information or heartbeat information.

5. The electronic device as claimed in claim 1, wherein the at least one processor is configured to:
control the display to display a first background image based on a first luminance value corresponding to a minimum luminance value within the luminance range and a first color value within the color range, and
acquire the target luminance value and the target color value from the second captured image based on the second captured image being acquired after the first background image is displayed.

6. The electronic device as claimed in claim 5, wherein the at least one processor is configured to:
acquire a first brightness value of the region of interest from the second captured image,
control the display to display a second background image based on the first luminance value and a second color value that is different from the first color value, and
acquire the target luminance value and the target color value from a third captured image based on the third captured image which includes the user face being acquired after the second background image is displayed based on the first luminance value.

7. The electronic device as claimed in claim 6, wherein the at least one processor is configured to:
acquire a second brightness value of the region of interest from the third captured image,
acquire a signal-to-noise ratio (SNR) corresponding to a green channel from the region of interest in the third captured image based on the second brightness value exceeding the first brightness value, and
acquire the target luminance value and the target color value based on the signal-to-noise ratio (SNR).

8. The electronic device as claimed in claim 7, wherein the at least one processor is configured to:
change the first luminance value to a second luminance value based on the second brightness value not exceeding the first brightness value,
control the display to display the second background image based on the second luminance value and the second color value,
acquire a third brightness value of the region of interest from a fourth captured image based on the fourth captured image which includes the user face being acquired after the second background image is displayed based on the second luminance value,
acquire the signal-to-noise ratio (SNR) corresponding to the green channel from the region of interest in the fourth captured image based on the third brightness value exceeding the first brightness value, and
acquire the target luminance value and the target color value based on the signal-to-noise ratio (SNR).

9. The electronic device as claimed in claim 7, wherein the at least one processor is configured to:
determine whether the signal-to-noise ratio (SNR) exceeds a pre-stored maximum signal-to-noise ratio (SNR-max) based on the signal-to-noise ratio (SNR) exceeding a threshold value,
update the pre-stored maximum signal-to-noise ratio (SNR-max) to the signal-to-noise ratio (SNR) based on the signal-to-noise ratio (SNR) exceeding the pre-stored maximum signal-to-noise ratio (SNR-max),
acquire a luminance value used to acquire the signal-to-noise ratio (SNR) as the target luminance value, and
acquire a color value used to acquire the signal-to-noise ratio (SNR) as the target color value.

10. The electronic device as claimed in claim 7, wherein the at least one processor is configured to:
control the display to display a third background image based on the first luminance value and a third color value that is different from the second color value based on the signal-to-noise ratio (SNR) not exceeding a threshold value, and
acquire the target luminance value and the target color value from a fifth captured image including the user after the third background image is displayed based on the first luminance value.

11. A control method of an electronic device including a display for displaying a background image, the control method comprising:
identifying a region of interest including a user face from a first captured image acquired;
acquiring skin color information corresponding to the user face based on the region of interest;
acquiring a luminance range of the display and a color range of the background image based on the skin color information;
displaying the background image based on a target luminance value acquired from the luminance range and a target color value acquired from the color range; and
acquiring user biological information based on a second captured image which includes the user face of the first captured image, acquired after the background image is displayed.

12. The control method as claimed in claim 11, wherein in the acquiring of the user biological information,
the second captured image is acquired while the background image is displayed,
the region of interest including the user face is identified from the second captured image, and
the user biological information is acquired based on the region of interest.

13. The control method as claimed in claim 12, wherein in the acquiring of the user biological information,
the background image is displayed for a predetermined time based on the target luminance value and the target color value, and
the user biological information is acquired based on a color value of the region of interest included in a plurality of captured images acquired for the predetermined time.

14. The control method as claimed in claim 11, wherein the user biological information includes at least one of blood flow information or heartbeat information.

15. The control method as claimed in claim 11, further comprising:
displaying a first background image based on a first luminance value corresponding to a minimum luminance value within the luminance range and a first color value within the color range; and
acquiring the target luminance value and the target color value from the second captured image based on the second captured image being acquired after the first background image is displayed.
